(19) United States
(12) Patent Application Publication
(10) Pub. No.: US 2012/0170648 A1
(43) Pub. Date: Jul. 5, 2012

(54) FRAME SPLITTING IN VIDEO CODING

(75) Inventors: Ying Chen, San Diego, CA (US); Peisong Chen, San Diego, CA (US); Marta Karczewicz, San Diego, CA (US)

(73) Assignee: QUALCOMM INCORPORATED, San Diego, CA (US)

(21) Appl. No.: 13/341,368

(22) Filed: Dec. 30, 2011

Related U.S. Application Data
(60) Provisional application No. 61/430,104, filed on Jan. 5, 2011.
(60) Provisional application No. 61/435,098, filed on Jan. 21, 2011.
(60) Provisional application No. 61/454,166, filed on Mar. 18, 2011.
(60) Provisional application No. 61/492,751, filed on Jun. 2, 2011.

(51) Int. Cl. H04N 7/26

(52) U.S. Cl. 375/240.03; 375/240.24; 375/E07.176; 375/E07.027

(57) ABSTRACT

In one example, this disclosure describes a method of decoding a frame of video data comprising a plurality of block-sized coding units including one or more largest coding units (LCUs) that include a hierarchically arranged plurality of relatively smaller coding units. In this example, the method includes determining a granularity at which the hierarchically arranged plurality of smaller coding units has been split when forming independently decodable portions of the frame. The method also includes identifying an LCU that has been split into a first section and a second section using the determined granularity. The method also includes decoding an independently decodable portion of the frame that includes the first section of the LCU without the second section of the LCU.

This application claims the benefit of U.S. Provisional Application No. 61/430,104, filed on Jan. 5, 2011, U.S. Provisional Application No. 61/435,098, filed Jan. 21, 2011, U.S. Provisional Application No. 61/454,166, filed on Mar. 18, 2011, and U.S. Provisional Application No. 61/492,751, filed on Jun. 2, 2011, the entire contents of all of which are incorporated herein by reference.

### TECHNICAL FIELD

This disclosure relates to video coding techniques and, more particularly, frame splitting aspects of the video coding techniques.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), and extensions of such standards, to transmit and receive digital video information more efficiently. New video coding standards, such as the High Efficiency Video Coding (HEVC) standard being developed by the “Joint Collaborative Team—Video Coding” (JCT-VC), which is a collaboration between MPEG and ITU-T, are being developed. The emerging HEVC standard is sometimes referred to as H.265, although such a designation has not formally been made.

### SUMMARY

This disclosure describes techniques for splitting a frame of video data into independently decodable portions of the frame, sometimes referred to as slices. Consistent with the emerging HEVC standard, a block of video data may be referred to as a coding unit (CU). A CU may be split into sub-CUs according to a hierarchical quadtree structure. For example, syntax data within a bitstream may define a largest coding unit (LCU), which is a largest coding unit of a frame of video data in terms of the number of pixels. An LCU may be split into sub-CUs, and each sub-CU may be further split into sub-CUs. Syntax data for a bitstream may define a number of times an LCU may be split, referred to as maximum CU depth.

In general, techniques are described for splitting a frame of video data into independently decodable portions of the frame, which are referred to as “slices” in the emerging HEVC standard. Rather than restrict the content of these slices to one or more complete coding units (CUs), such as one or more complete largest coding units (LCUs) of a frame, the techniques described in this disclosure may provide a way by which slices may include a portion of an LCU. In enabling an LCU to be divided into two sections, the techniques may reduce the number of slices required when splitting any given frame. Reducing the number of slices may decrease overhead data in the form of slice header data that stores syntax elements used to decode the compressed video data, improving compression efficiency as the amount of overhead data decreases relative to the amount of compressed video data. In this manner, the techniques may promote more efficient storage and transmission of encoded video data.

In an example, aspects of this disclosure relate to a method of decoding a frame of video data comprising a plurality of block-sized coding units including one or more largest coding units (LCUs) that include a hierarchically arranged plurality of relatively smaller coding units. The method includes determining a granularity at which the hierarchically arranged plurality of smaller coding units has been split when forming independently decodable portions of the frame; identifying an LCU that has been split into a first section and a second section using the determined granularity; and decoding an independently decodable portion of the frame that includes the first section of the LCU without the second section of the LCU.

In another example, aspects of this disclosure relate to an apparatus for decoding a frame of video data comprising a plurality of block-sized coding units including one or more largest coding units (LCUs) that include a hierarchically arranged plurality of relatively smaller coding units. The apparatus includes one or more processors configured to: determine a granularity at which the hierarchically arranged plurality of smaller coding units has been split when forming independently decodable portions of the frame; identify an LCU that has been split into a first section and a second section using the determined granularity; and decode an independently decodable portion of the frame that includes the first section of the LCU without the second section of the LCU.

In another example, aspects of this disclosure relate to an apparatus for decoding a frame of video data comprising a plurality of block-sized coding units including one or more largest coding units (LCUs) that include a hierarchically arranged plurality of relatively smaller coding units. The apparatus includes means for determining a granularity at which the hierarchically arranged plurality of smaller coding units has been split when forming independently decodable portions of the frame; means for identifying an LCU that has been split into a first section and a second section using the determined granularity; and means for decoding an independently decodable portion of the frame that includes the first section of the LCU without the second section of the LCU.

In another example, aspects of this disclosure relate to a computer-readable storage medium storing instructions that, upon execution by one or more processors, cause the one or more processors to perform a method for decoding a frame of video data comprising a plurality of block-sized coding units including one or more largest coding units (LCUs) that include a hierarchically arranged plurality of relatively smaller coding units. The method includes determining a granularity at which the hierarchically arranged plurality of smaller coding units has been split when forming independently decodable portions of the frame; identifying an LCU that has been split into a first section and a second section using the determined granularity; and decoding an independently decodable portion of the frame that includes the first section of the LCU without the second section of the LCU.

In another example, aspects of this disclosure relate to a method of encoding a frame of video data comprising a plurality of block-sized coding units including one or more largest coding units (LCUs) that include a hierarchically arranged plurality of relatively smaller coding units. The method includes determining a granularity at which the hierarchically arranged plurality of smaller coding units is to be split when forming independently decodable portions of the frame; splitting an LCU using the determined granularity to generate a first section of the LCU and a second section of the LCU; generating an independently decodable portion of the frame to include the first section of the LCU without including the second section of the LCU; and generating a bitstream to include the independently decodable portion of the frame and an indication of the determined granularity.

In another example, aspects of this disclosure relate to an apparatus for encoding a frame of video data comprising a plurality of block-sized coding units including one or more largest coding units (LCUs) that include a hierarchically arranged plurality of relatively smaller coding units. The apparatus includes one or more processors configured to: determine a granularity at which the hierarchically arranged plurality of smaller coding units is to be split when forming independently decodable portions of the frame; split an LCU using the determined granularity to generate a first section of the LCU and a second section of the LCU; generate an independently decodable portion of the frame to include the first section of the LCU without including the second section of the LCU; and generate a bitstream to include the independently decodable portion of the frame and an indication of the determined granularity.

In another example, aspects of this disclosure relate to an apparatus for encoding a frame of video data comprising a plurality of block-sized coding units including one or more largest coding units (LCUs) that include a hierarchically arranged plurality of relatively smaller coding units. The apparatus includes means for determining a granularity at which the hierarchically arranged plurality of smaller coding units is to be split when forming independently decodable portions of the frame; means for splitting an LCU using the determined granularity to generate a first section of the LCU and a second section of the LCU; means for generating an independently decodable portion of the frame to include the first section of the LCU without including the second section of the LCU; and means for generating a bitstream to include the independently decodable portion of the frame and an indication of the determined granularity.

In another example, aspects of this disclosure relate to a computer-readable storage medium storing instructions that, upon execution by one or more processors, cause the one or more processors to perform a method for encoding a frame of video data comprising a plurality of block-sized coding units including one or more largest coding units (LCUs) that include a hierarchically arranged plurality of relatively smaller coding units. The method includes determining a granularity at which the hierarchically arranged plurality of smaller coding units is to be split when forming independently decodable portions of the frame; splitting an LCU using the determined granularity to generate a first section of the LCU and a second section of the LCU; generating an independently decodable portion of the frame to include the first section of the LCU without including the second section of the LCU; and generating a bitstream to include the independently decodable portion of the frame and an indication of the determined granularity.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating a video encoding and decoding system that may implement one or more of the techniques of this disclosure.

FIG. 2 is a conceptual diagram illustrating quadtree partitioning of coded units (CUs) consistent with the techniques of this disclosure.

FIG. 3A is a conceptual diagram illustrating splitting a quadtree of CUs into slices consistent with the techniques of this disclosure.

FIG. 3B is a conceptual diagram illustrating splitting CUs into slices consistent with the techniques of this disclosure.

FIG. 4 is a block diagram illustrating a video encoder that may implement the techniques of this disclosure.

FIG. 5 is a block diagram illustrating a video decoder that may implement the techniques of this disclosure.

FIG. 6 is a flow diagram illustrating a method of encoding video data consistent with the techniques described in this disclosure.

FIG. 7 is a flow diagram illustrating a method of decoding video data consistent with the techniques described in this disclosure.

### DETAILED DESCRIPTION

The techniques of this disclosure generally include splitting a frame of video data into independently decodable portions, where a boundary between the independently decodable portions may be positioned within a coding unit (CU), such as a largest CU (LCU) specified in the HEVC standard. For example, aspects of the disclosure may relate to determining a granularity at which to split a frame of video data, splitting the frame using the determined granularity, and identifying the granularity using CU depth. The techniques of this disclosure may also include generating and/or decoding a variety of parameters associated with splitting the frame into independently decodable portions. For example, aspects of this disclosure may relate to identifying the granularity used to split the frame of video data using CU depth, identifying separate portions of the hierarchical quadtree structure for each independently decodable portion, and identifying changes (i.e., deltas) in a quantization parameter (i.e., the delta QP) for each independently decodable portion.

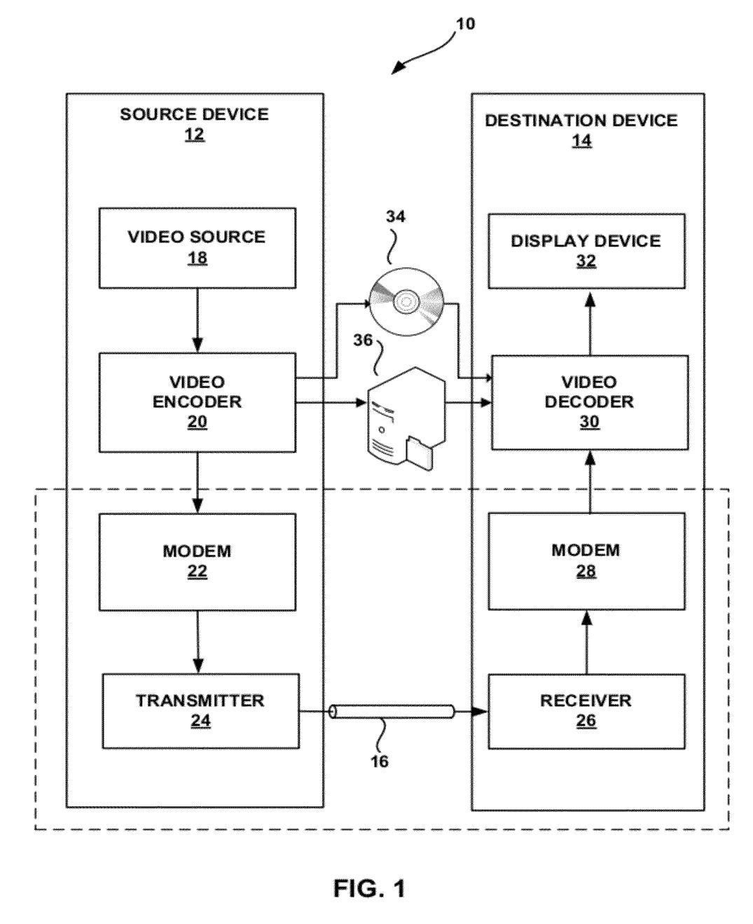

FIG. 1 is a block diagram illustrating an example video encoding and decoding system 10 that may be configured to utilize the techniques described in this disclosure for splitting frames of video data into independently decodable portions. According to aspects of this disclosure, independently decodable portions of a frame of video data may be generally referred to as “slices” of video data consistent with various video coding standards, including the proposed so-called high efficiency video coding (HEVC) standard. A slice may be described as being independently decodable because a slice of a frame does not rely on other slices of the same frame for information and therefore may be decoded independently of any other slice, hence the name “independently decodable portion.” By ensuring that slices are independently decodable, errors or missing data in one slice do not propagate into any other slice within the frame. Isolating errors to a single slice within a frame may also assist attempts to compensate for such errors.

As shown in the example of FIG. 1, system 10 includes a source device 12 that generates encoded video for decoding by destination device 14. Source device 12 may transmit the encoded video to destination device 14 via communication channel 16 or may store the encoded video on a storage medium 34 or a file server 36, such that the encoded video may be accessed by the destination device 14 as desired. Source device 12 and destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like.

In many cases, such devices may be equipped for wireless communication. Hence, communication channel 16 may comprise a wireless channel, a wired channel, or a combination of wireless and wired channels suitable for transmission of encoded video data. For example, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

The techniques described in this disclosure for splitting frames of video data into slices, in accordance with examples of this disclosure, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

As further shown in the example of FIG. 1, source device 12 includes a video source 18, video encoder 20, a modulator/demodulator 22 and a transmitter 24. In source device 12, video source 18 may include a source such as a video capture device. The video capture device, by way of example, may include one or more of a video camera, a video archive containing previously captured video, a video feed interface to receive video from a video content provider, and/or a computer graphics system for generating computer graphics data as the source video. As one example, if video source 18 is a video camera, source device 12 and destination device 14 may form so-called camera phones or video phones. The techniques of this disclosure, however, are not necessarily limited to wireless applications or settings, and may be applied to non-wireless devices including video encoding and/or decoding capabilities. Source device 12 and destination device 16 are merely examples of coding devices that can support the techniques described herein.

The captured, pre-captured, or computer-generated video may be encoded by video encoder 20. The encoded video information may be modulated by modem 22 according to a communication standard, such as a wireless communication protocol, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

The captured, pre-captured, or computer-generated video that is encoded by the video encoder 20 may also be stored onto a storage medium 34 or a file server 36 for later consumption. The storage medium 34 may include Blu-ray discs, DVDs, CD-ROMs, flash memory, or any other suitable digital storage media for storing encoded video. The encoded video stored on the storage medium 34 may then be accessed by destination device 14 for decoding and playback.

File server 36 may be any type of server capable of storing encoded video and transmitting that encoded video to the destination device 14. Example file servers include a web server (e.g., for a website), an FTP server, network attached storage (NAS) devices, a local disk drive, or any other type of device capable of storing encoded video data and transmitting it to a destination device. The file server 36 may be accessed by the destination device 14 through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the file server 36 may be a streaming transmission, a download transmission, or a combination of both.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to storage medium 34 or file server 36) prior to being received and decoded by video decoder 30. Thus, the term “signaling” may generally refer to the communication of syntax or other data necessary to decode the compressed video data, whether such communication occurs in real- or near-real-time or over a span of time, such as might occur when storing syntax elements to a medium at the time of encoding, which then may be retrieved by a decoding device at any time after being stored to this medium.

Destination device 14, in the example of FIG. 1, includes a receiver 26, a modem 28, a video decoder 30, and a display device 32. Receiver 26 of destination device 14 receives information over channel 16, and modem 28 demodulates the information to produce a demodulated bitstream for video decoder 30. The information communicated over channel 16 may include a variety of syntax information generated by video encoder 20 for use by video decoder 30 in decoding video data. Such syntax may also be included with the encoded video data stored on a storage medium 34 or a file server 36. Each of video encoder 20 and video decoder 30 may form part of a respective encoder-decoder (CODEC) that is capable of encoding or decoding video data.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples include MPEG-2 and ITU-T H.263.

The HEVC standard refers to a block of video data as a coding unit (CU). In general, a CU has a similar purpose to a macroblock coded according to H.264, except that a CU does not have a size distinction. Thus, a CU may be split into sub-CUs. In general, references in this disclosure to a CU may refer to a largest coding unit (LCU) of a picture or a sub-CU of an LCU. For example, syntax data within a bitstream may define the LCU, which is a largest coding unit in terms of the number of pixels. An LCU may be split into sub-CUs, and each sub-CU may be split into sub-CUs. Syntax data for a bitstream may define a maximum number of times an LCU may be split, referred to as a maximum CU depth. Accordingly, a bitstream may also define a smallest coding unit (SCU).

An LCU may be associated with a hierarchical quadtree data structure. In general, a quadtree data structure includes one node per CU, where a root node corresponds to the LCU. If a CU is split into four sub-CUs, the node corresponding to the CU includes four leaf nodes, each of which corresponds to one of the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs.

A CU that is not split may include one or more prediction units (PUs). In general, a PU represents all or a portion of the corresponding CU, and includes data for retrieving a reference sample for the PU. For example, when the PU is intra-mode encoded, the PU may include data describing an intra-prediction mode for the PU. As another example, when the PU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the CU defining the PU(s) may also describe, for example, partitioning of the CU into one or more PUs. Partitioning modes may differ between whether the CU is uncoded, intra-prediction mode encoded, or inter-prediction mode encoded.

A CU having one or more PUs may also include one or more transform units (TUs). Following prediction using a PU, a video encoder may calculate a residual value for the portion of the CU corresponding to the PU. The residual value may be transformed, quantized, and scanned. A TU is not necessarily limited to the size of a PU. Thus, TUs may be larger or smaller than corresponding PUs for the same CU. In some examples, the maximum size of a TU may be the size of the corresponding CU. This disclosure also uses the term “block” to refer to any of a CU, PU, or TU.

While aspects of this disclosure may refer to a “largest coding unit (LCU)” as specified in the proposed HEVC standard, it should be understood that the scope of the term “largest coding unit” is not limited to the proposed HEVC standard. For example, the term largest coding unit may generally refer to a relative size of a coding unit as the coding unit relates to other coding units of encoded video data. In other words, a largest coding unit may refer to the relative largest coding unit in a frame of video data having one or more differently sized coding units (e.g., in comparison to other coding units in the frame). In another example, the term largest coding unit may refer to a largest coding unit as specified in the proposed HEVC standard, which may have associated syntax elements (e.g., syntax elements that describe a hierarchical quadtree structure, and the like).

In general, encoded video data may include prediction data and residual data. Video encoder 20 may produce the prediction data during an intra-prediction mode or an inter-prediction mode. Intra-prediction generally involves predicting the pixel values in a block of a picture relative to reference samples in neighboring, previously coded blocks of the same picture. Inter-prediction generally involves predicting the pixel values in a block of a picture relative to data of a previously coded picture.

Following intra- or inter-prediction, video encoder 20 may calculate residual pixel values for the block. The residual values generally correspond to differences between the predicted pixel value data for the block and the true pixel value data of the block. For example, the residual values may include pixel difference values indicating differences between coded pixels and predictive pixels. In some examples, the coded pixels may be associated with a block of pixels to be coded, and the predictive pixels may be associated with one or more blocks of pixels used to predict the coded block.

To further compress the residual value of a block, the residual value may be transformed into a set of transform coefficients that compact as much data (also referred to as “energy”) as possible into as few coefficients as possible. Transform techniques may comprise a discrete cosine transform (DCT) process or conceptually similar process, integer transforms, wavelet transforms, or other types of transforms. The transform converts the residual values of the pixels from the spatial domain to a transform domain. The transform coefficients correspond to a two-dimensional matrix of coefficients that is ordinarily the same size as the original block. In other words, there are just as many transform coefficients as pixels in the original block. However, due to the transform, many of the transform coefficients may have values equal to zero.

Video encoder 20 may then quantize the transform coefficients to further compress the video data. Quantization generally involves mapping values within a relatively large range to values in a relatively small range, thus reducing the amount of data needed to represent the quantized transform coefficients. More specifically, quantization may be applied according to a quantization parameter (QP), which may be defined at the LCU level. Accordingly, the same level of quantization may be applied to all transform coefficients in the TUs associated with different PUs of CUs within an LCU. However, rather than signal the QP itself, a change (i.e., a delta) in the QP may be signaled with the LCU. The delta QP defines a change in the quantization parameter for the LCU relative to some reference QP, such as the QP of a previously communicated LCU.

Following quantization, video encoder 20 may scan the transform coefficients, producing a one-dimensional vector from the two-dimensional matrix including the quantized transform coefficients. Video encoder 20 may then entropy encode the resulting array to even further compress the data. In general, entropy coding comprises one or more processes that collectively compress a sequence of quantized transform coefficients and/or other syntax information. For example, syntax elements, such as the delta QPs, prediction vectors, coding modes, filters, offsets, or other information, may also be included in the entropy coded bitstream. The scanned coefficients are then entropy coded along with any syntax information, e.g., via content adaptive variable length coding (CAVLC), context adaptive binary arithmetic coding (CABAC), or another entropy coding process.

Again, the techniques of this disclosure include splitting a frame of video data into independently decodable slices. In some instances, video encoder 20 may form slices that are of a particular size. One such instance may be in preparation to transmit slices over an Ethernet network or any other type of network whose layer two (L2) architecture utilizes the Ethernet protocol (where layers followed by a number in this context refer to the corresponding layer of the Open System Interconnection (OSI) model). In this example, video encoder 20 may form slices that are only slightly smaller than a maximum transmission unit (MTU), which may be 1500 bytes.

Typically, video encoders split a slice following an LCU. That is, video encoders may be configured to restrict slice granularity to the size of an LCU, such that a slice contains one or more full LCUs. Limiting slice granularity to an LCU, however, may present challenges when attempting to form slices of a certain size. For example, video encoders configured in this manner may not be able to generate a slice of a particular size (e.g., a slice that includes a predetermined quantity of data) in frames having relatively large LCUs. That is, relatively large LCUs may result in a slice being significantly under the desired size. This disclosure generally refers to “granularity” as the extent to which a block of video data, such as an LCU, may be broken down into smaller parts (e.g., divided) when generating a slice. Such granularity may also be generally referred to as “slice granularity.” That is, granularity (or slice granularity) may refer to the relative size of sub-CUs within an LCU that may be divided into different slices. As described in greater detail below, granularity may be identified according to a hierarchical CU depth at which a slice split occurs.

To illustrate consider the example of the 1500 byte target maximum slice size provided above. In this illustration, a video encoder configured with full-LCU slice granularity may generate a first LCU of 500 bytes, a second LCU of 400 bytes and a third LCU of 900 bytes. The video encoder may store the first and second LCUs to the slice for a total slice size of 900 bytes, where addition of the third LCU may exceed the 1500 byte maximum slice size by approximately 300 bytes (900 byres+900 bytes-300 bytes=300 bytes). Thus, a final LCU of a slice may not fill the slice to this target maximum capacity, and the remaining capacity of the slice may not be large enough to accommodate another full LCU. Consequently, the slice may only store the first and second LCU with another slice being generated to store the third LCU and potentially any additional LCUs having a size less than the 1500 byte target size minus the 900 bytes of the third LCU, or 900 bytes. Because two slices are required rather than three, the second slice introduces additional overhead in the form of slice headers, creating bandwidth and storage inefficiencies.

In accordance with the techniques described in this disclosure, video encoder 20 may split a frame of video data into slices at a granularity that is smaller than an LCU. That is, according to aspects of this disclosure, video encoder 20 may split a frame of video data into slices using a boundary that may be positioned within an LCU. In an example, video encoder 20 may split a frame of video data having a plurality of block-sized CUs including one or more LCUs that include a hierarchically arranged plurality of relatively smaller coding units into independently decodable slices. In this example, video encoder 20 may determine a granularity at which the hierarchically arranged plurality of smaller coding units is to be split when forming independently decodable portions of the frame. Video encoder 20 may also split an LCU using the determined granularity to generate a first section of the LCU and a second section of the LCU. Video encoder 20 may also generate an independently decodable portion of the frame to include the first section of the LCU without including the second section of the LCU. Video encoder 20 may also generate a bitstream to include the independently decodable portion of the frame and an indication of the determined granularity.

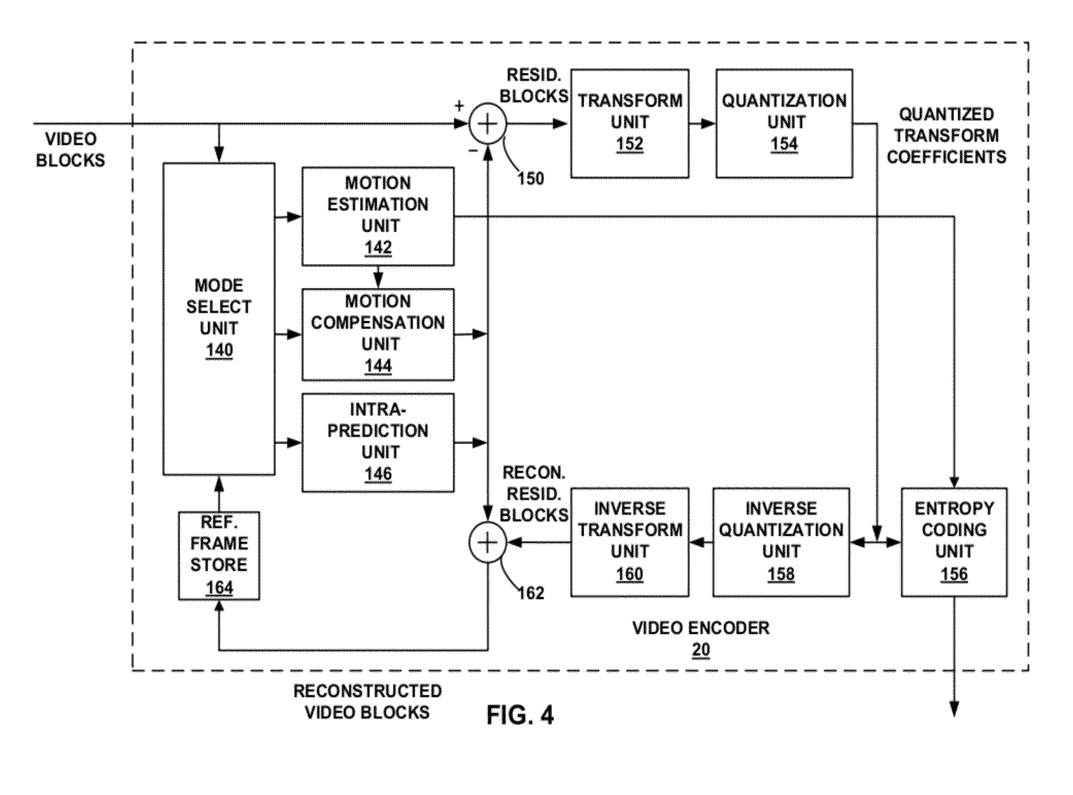

Video encoder 20 may consider a variety of parameters when determining the granularity at which to split a frame into independently decodable slices. For example, as noted above, video encoder 20 may determine the granularity at which to split a frame based on a desired slice size. In other examples, as described in greater detail with respect to FIG. 4, video encoder 20 may consider error results versus the number of bits required to signal the video data (e.g., sometimes referred to as rate-distortion) and base the determination of granularity on these error results versus (or in comparison to) the number of bits required to signal the video data.

In an example, video encoder 20 may determine that a frame of video data is to be split into slices at a granularity that is smaller than an LCU. As merely one example provided for purposes of illustration, an LCU associated with a frame of video data may be 64 pixels by 64 pixels in size. In this example, video encoder 20 may determine that the frame is to be split into slices using a CU granularity of 32 pixels by 32 pixels. That is, video encoder 20 may divide the frame into slices using a boundary between CUs that are 32 pixels by 32 pixels in size or larger. Such a granularity may be implemented, for example, in order to achieve a particular slice size. In some examples, the granularity may be represented using CU depth. That is, for an LCU that is 64 pixels by 64 pixels in size that is to be split into slices at a granularity of 32 pixels by 32 pixels, the granularity can be represented by a CU depth of 1.

Next, video encoder 20 may split the frame into slices by splitting an LCU at the determined granularity to generate a first section of the LCU and a second section of the LCU. In the example provided above, video encoder 20 may split the final LCU of a prospective slice into a first and second section. That is, the first section of the LCU may include one or more 32 pixel by 32 pixel blocks of video data associated with the LCU, while the second section of the LCU may include the remaining 32 pixel by 32 pixel blocks associated with the LCU. Although specified as including the same size of pixel blocks in the example above, each section may include a different number of pixel blocks. For example, the first section may include 8 pixel by 8 pixel blocks while the second section may include the remaining three 8 pixel by 8 pixel blocks. In addition, although described as being square pixel blocks in the example above, each section may comprise rectangular pixel blocks or any other type of pixel block.

In this manner, video encoder 20 may generate an independently decodable portion of the frame, e.g., a slice, that includes the first section of the LCU without including the second section of the LCU. For example, video encoder 20 may generate a slice that contains one or more full LCUs, as well as the first section of the split LCU identified above. Video encoder 20 may therefore implement the techniques described in this disclosure to generate a slice at a granularity smaller than the LCU, which may provide flexibility when attempting to form a slice of a particular size (e.g., a predetermined quantity of data). In some examples, video encoder 20 may apply the determined granularity to a group of pictures (e.g., more than one frame).

Video encoder 20 may also generate a bitstream to include the independently decodable portion of the frame and an indication of the determined granularity. That is, video encoder 20 may signal a granularity at which one or more pictures may be split into slices, followed by the one or more pictures. In some examples, video encoder 20 may indicate the granularity by identifying the CU depth at which the frame may be split into slices. In such examples, video encoder 20 may include one or more syntax elements based on the granularity, which may be signaled as CU depth in the bitstream. In addition, video encoder 20 may indicate an address at which the slice begins (e.g., a “slice address”). The slice address may indicate a relative position at which a slice begins within a frame. The slice address may be provided at the slice granularity level. In some examples, the slice address may be provided in a slice header.

According to aspects of this disclosure, video decoder 30 may decode independently decodable portions of a video frame. For example, video decoder 30 may receive a bitstream containing one or more independently decodable portions of a video frame and decode the bitstream. More specifically, video decoder 30 may decode independently decodable slices of video data, where the slices were formed at a granularity less than an LCU of the frame. That is, for example, video decoder 30 may be configured to receive a slice that was formed at a granularity less than an LCU and reconstruct the slice using data included in the bitstream. In an example, as described in greater detail below, video decoder 30 may determine the granularity based on one or more syntax elements included in the bitstream (e.g., a syntax element that identifies a CU depth at which the slice was split, one or more split flags, and the like).

The slice granularity may apply to one picture or may to apply to a number of pictures (e.g., a group of pictures). For example, the slice granularity can be signaled in a parameter set, such as a picture parameter set (PPS). A PPS generally contains parameters that may be applied to one or more pictures within a sequence of pictures (e.g., one or more frames of video data). Typically, a PPS may be sent to decoder 30 prior to decoding a slice (e.g., prior to decoding a slice header and slice data). Syntax data in a slice header may refer to a certain PPS, which may “activate” that PPS for the slice. That is, video decoder 30 may apply the parameters signaled in the PPS upon decoding the slice header. According to some examples, once a PPS has been activated for a particular slice, the PPS may remain active until a different picture parameter set is activated (e.g., by being referred to in another slice header).

As noted above, according to aspects of this disclosure, slice granularity may be signaled in a parameter set, such as a PPS. Accordingly, a slice may be assigned a particular granularity by referring to a specific PPS. That is, video decoder 30 may decode header information associated with a slice, which may refer to a particular PPS for the slice. The video decoder 30 may then apply the slice granularity identified in the PPS to the slice when decoding the slice. In addition, according to aspects of this disclosure, video decoder 30 may decode information that indicates an address at which a slice begins (e.g., a “slice address”). The slice address may be provided in a slice header at the slice granularity level. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

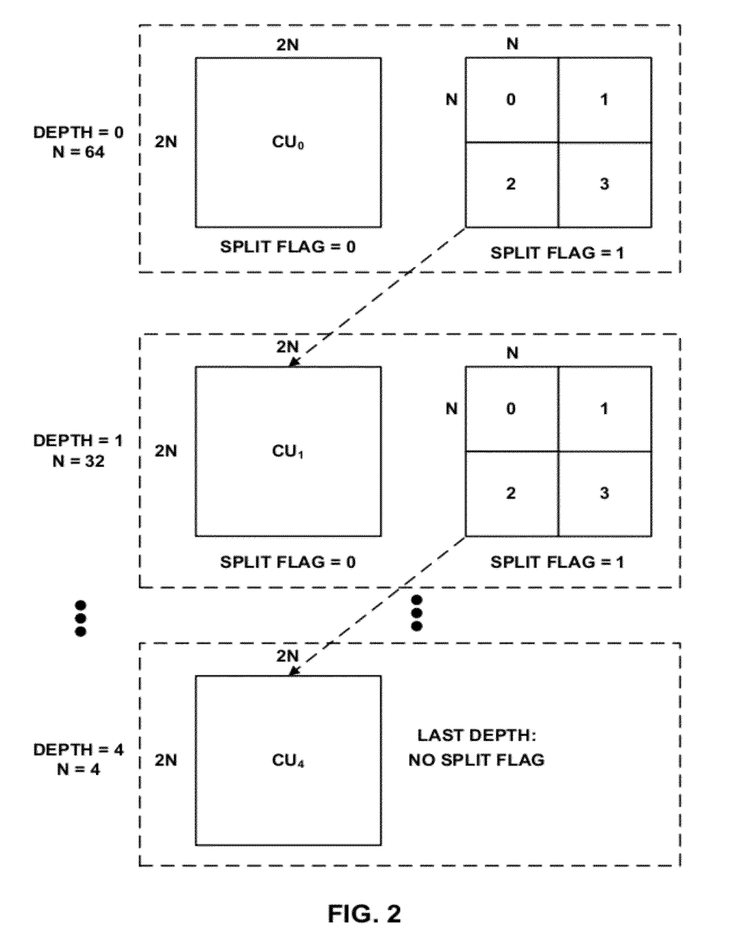

FIG. 2 is a conceptual diagram illustrating a hierarchical quadtree partitioning of coded units (CUs) consistent with the techniques of this disclosure and the emerging HEVC standard. In the example shown in FIG. 2, an LCU (CU₀) is 128 pixels by 128 pixels in size. That is, CU₀ is 128 pixels by 128 pixels in size (e.g., N=64) at an undivided CU depth 0. Video encoder 20 may determine whether to split CU₀ into four quadrants, each comprising a sub-CU, or whether to encode CU₀ without splitting. This decision may be made, for example, based on the complexity of the video data associated with CU₀, where more complex video data increases the probability of a split.

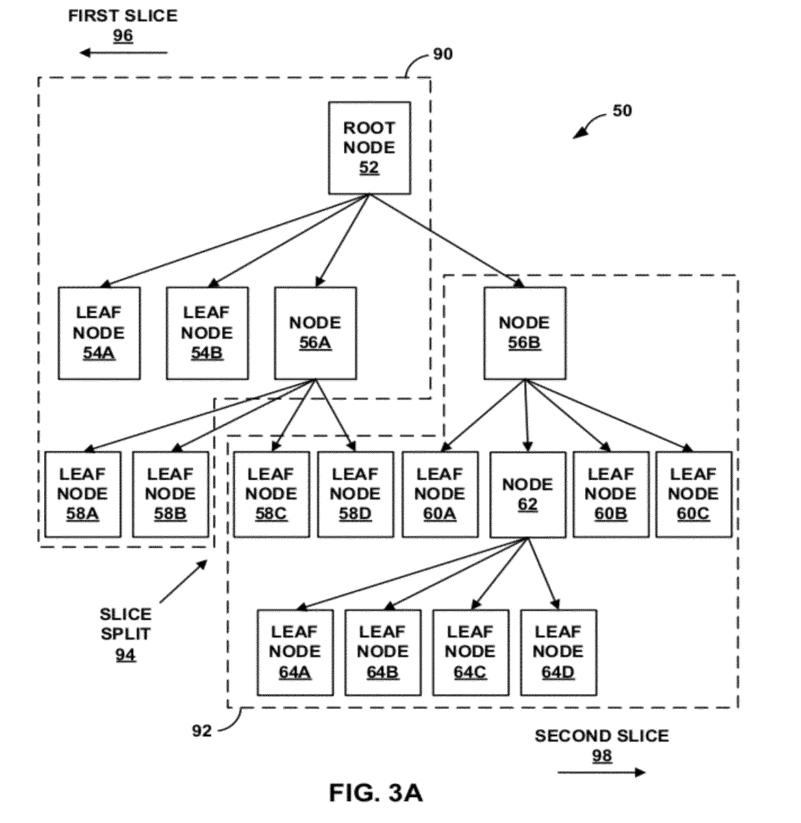

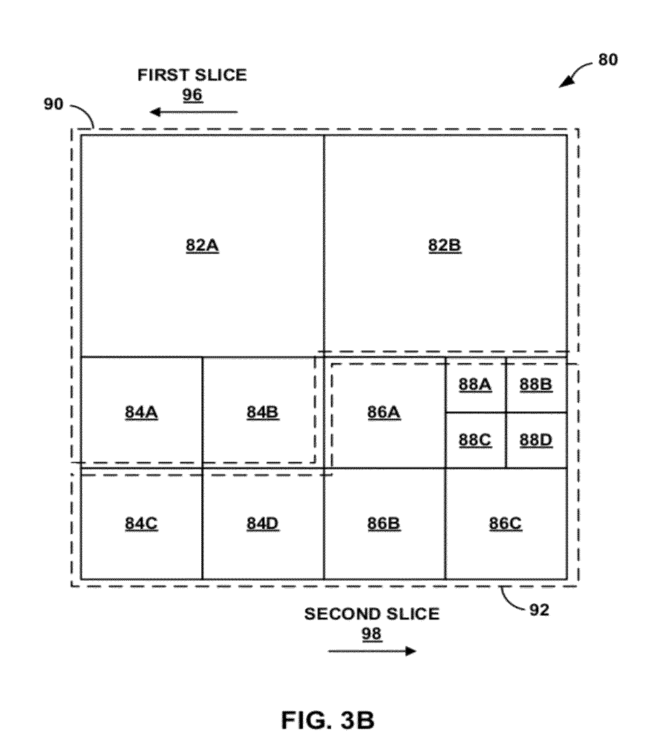

The decision to split the CU₀ may be represented by a split flag. In general, a split flag may be included as a syntax element in a bitstream. That is, if CU₀ is not split, a split flag may be set to 0. Conversely, if CU₀ is split into quadrants comprising sub-CUs, the split flag may be set to 1. As described in greater detail with respect to FIGS. 3A and 3B, a video encoder, such as video encoder 20 (FIG. 1), may represent a quadtree data structure that indicates the splitting of an LCU and sub-CUs of the LCU using the split flags.

CU depth may used to indicate the number of times that an LCU, such as CUₒ, has been split. For example, after splitting CU₀ (e.g., split flag=1), the resulting sub-CUs have a depth of 1. The CU depth of a CU may also provide an indication of the size of that CU, provided the LCU size is known. In the example shown in FIG. 2, CU₀ is 128 pixels by 128 pixels in size. Accordingly, each CU at depth 1 (shown in the example of FIG. 2 as CU₁), is 64 pixels by 64 pixels in size.

In this manner, CUs may be recursively divided into sub-CUs until a maximum hierarchical depth is reached. A CU cannot be divided beyond the maximum hierarchical depth. In the example shown in FIG. 2, CU₀ can be divided into sub-CUs until a maximum hierarchical depth of 4 has been reached. At a CU depth of 4 (e.g., CU₄), the CUs are 8 pixels by 8 pixels in size.

While CU₀ is shown in the example of FIG. 2 as being 128 pixels by 128 pixels in size and having a maximum hierarchical depth of 4, it is provided as merely one example for purposes of illustration. Other examples may include LCUs that are larger or smaller and that have the same or an alternative maximum hierarchical depth.

FIGS. 3A and 3B are conceptual diagrams illustrating an example quadtree 50 and a corresponding largest coding unit 80, consistent with the techniques of this disclosure. Quadtree 50 includes nodes arranged in a hierarchical fashion. Each node may be a leaf node with no children, or may have four child nodes, hence the name “quadtree.” In the example of FIG. 3A, quadtree 50 includes root node 52. Root node 52 has four child nodes, including leaf nodes 54A and 54B (leaf nodes 54) and nodes 56A and 56B (nodes 56). Because nodes 56 are not leaf nodes, nodes 56 each include four child nodes. That is, in the example shown in FIG. 3A, node 56A has four child leaf nodes 58A-58D, while node 56B has three leaf nodes 60A-60C (leaf nodes 60) and node 62. In addition, node 62 has four leaf nodes 64A-64D (leaf nodes 64).

Quadtree 50 may include data describing characteristics of a corresponding largest coding unit (LCU), such as LCU 80 in this example. For example, quadtree 50, by its structure, may describe splitting of LCU 80 into sub-CUs. Assume that LCU 80 has a size of 2N×2N. In this example, LCU 80 has four sub-CUs, with two sub-CUs 82A and 82B (sub-CUs 82) of a size N×N. The remaining two sub-CUs of LCU 80 are further split into smaller sub-CUs. That is, in the example shown in FIG. 3B, one of the sub-CUs of LCU 80 is split into sub-CUs 84A-84D of size N/2×N/2, while the other sub-CU of LCU 80 is split into sub-CUs 86A-86C (sub-CUs 86) of size N/2×N/2 and a further divided sub-CU, identified as sub-CUs 88A-88D (sub-CUs 88) of a size N/4×N/4.

In the example shown in FIGS. 3A and 3B, the structure of quadtree 50 corresponds to the splitting of LCU 80. That is, root node 52 corresponds to LCU 80 and leaf nodes 54 correspond to sub-CUs 82. Moreover, leaf nodes 58 (which is a child node of node 56A, which typically means that node 56A includes a pointer referencing leaf node 58) correspond to sub-CUs 84, leaf nodes 60 (e.g., belonging to node 56B) correspond to sub-CUs 86, and leaf nodes 64 (e.g., belonging to node 62) correspond to sub-CUs 88.

In the example shown in FIGS. 3A and 3B, LCU 80 (which corresponds to root node 52), is split into a first section 90 and a second section 92. According aspects of the disclosure, a video encoder, such as video encoder 20, may split LCU 80 into the first section 90 and the second section 92 and include the first section 90 with a first independently decodable portion of a frame from which LCU 80 belongs, and may include the second section 92 with a second independently decodable portion of the frame from which LCU 80 belongs. That is, video encoder 20 may split a frame of video data containing LCU 80 into slices (e.g., as indicated by “slice split” arrow 94) such that a first slice (e.g., as indicated by arrow 96) includes the first section 90 and a second slice (e.g., as indicated by arrow 98) includes the second section 92. For example, the first slice 96 may include one or more complete LCUs in addition to the first section 90 of LCU 80, which may be positioned as the relative end of the slice. Likewise, the second slice 98 may begin with the second section 92 of LCU 80 and include one or more additional other LCUs.

To split a frame of video data containing LCU 80 into independently decodable slices in the manner shown and described with respect to FIGS. 3A and 3B, the granularity at which the slices are generated must be less than the size of LCU 80, in accordance with the techniques of this disclosure. In an example, assume for purposes of explanation that LCU 80 is 64 pixels by 64 pixels in size (e.g., N=32). In this example, the slice granularity is 16 pixels by 16 pixels. For example, the sizes of the smallest CUs that are separated by a slice boundary are 16 pixels by 16 pixels in size.

The granularity at which an LCU of a frame, such as LCU 80, may be split into slices may be identified according to the CU depth value at which the split occurs. In the example of FIG. 3A, slice split 94 occurs at a CU depth of 2. For example, the boundary between the first section 90 that may be included with the first slice 96 and the second section 92 that may be included with the second slice 98 is positioned between leaf nodes 58B and 58C, which are located at a CU depth of 2.

The example shown in FIG. 3B further conceptually illustrates the granularity at which LCU 80 is divided. For example, this disclosure may generally refer to “granularity” as the extent to which an LCU is divided when generating a slice. As shown in FIG. 3B, the sub-CUs 84 of LCU 80 are the smallest CUs through which the boundary between the first section 90 and the second section 92 is positioned. That is, the boundary by which the first section 90 is separated from the second section 92 is positioned between sub-CUs 84A/84B and sub-CUs 84C/84D. Accordingly, in this example, the final CU of slice 96 is sub-CU 84B, while the initial CU of slice 98 is sub-CU 84C.

Generating slices using a CU granularity smaller than LCU 80 may provide flexibility when attempting to form a slice of a particular size (e.g., a predetermined quantity of data). Moreover, as noted above, splitting a frame into slices according to the techniques of this disclosure may reduce the number of slices required to specify compressed video data. Reducing the number of slices required to specify compressed video data may decrease overhead data (e.g., overhead associated with slice headers), thereby improving compression efficiency as the amount of overhead data decreases relative to the amount of compressed video data.

When splitting a frame containing LCU 80 into independently decodable slices 96 and 98, according to aspects of this disclosure, the hierarchical quadtree information for LCU 80 may be separated and presented with each independently decodable slice. For example, as noted above, data for nodes of quadtree 50 may describe whether the CU corresponding to the node is split. If the CU is split, four additional nodes may be present in quadtree 50. In some examples, a node of a quadtree may be implemented similar to the following pseudocode:

```
quadtree_node {
      boolean split_flag(1);
      // signaling data
      if (split_flag) {
            quadtree_node child1;
            quadtree_node child2;
            quadtree_node child3;
            quadtree_node child4;
      }
}
```

The split_flag value may be a one-bit value representative of whether the CU corresponding to the current node is split. If the CU is not split, the split_flag value may be ‘0’, while if the CU is split, the split_flag value may be ‘1’. With respect to the example of quadtree 50, an array of split flag values may be 10011000001000000.

Quadtree information, such as quadtree 50 associated with LCU 80, is typically provided at the beginning of the slice containing the LCU 80. If the LCU 80 is divided into different slices, however, and the slice containing the quadtree information is lost or corrupt, a video decoder may not be able to properly decode the portion of the LCU 80 contained in the second slice 98 (e.g., the slice without the quadtree information). That is, the video decoder may not be able to identify how the remainder of the LCU 80 is split into sub-CUs.

Aspects of this disclosure include separating hierarchical quadtree information for an LCU being split into different slices, such as LCU 80, and presenting the separated portions of the quadtree information with each slice. For example, video encoder 20 may typically provide quadtree information in the form of split flags at the beginning of LCU 80. If the quadtree information for LCU 80 is provided in this way, however, the first section 90 may include all of the split flags while the second section 92 does not include any split flags. If the first slice 96 (which contains the first section 90) is lost or corrupted, the second slice 98 (which contains the second section 92) may not be able to be decoded properly.

When splitting LCU 80 into different slices, according to aspects of this disclosure, video encoder 20 may also separate the associated quadtree information so that the quadtree information that is applicable to the first section 90 is provided with the first slice 96 and the quadtree information that is applicable to the second section 92 is provided with the second slice 96. That is, when splitting LCU 80 into the first section 90 and the second section 92, video encoder 20 may separate the split flags associated with the first section 90 from the split flags associated with the second section 92. Video encoder 20 may then provide the split flags for the first section 90 with the first slice 96 and the split flags for the second section 92 with the second slice 98. In this way, if the first slice 96 is corrupted or lost, a video decoder may still be able to properly decode the remaining portion of LCU 80 that is included with the second slice 98.

In order to properly decode a section of an LCU that contains only a portion of the quadtree information for the LCU, in some examples, video decoder 30 may reconstruct the quadtree information associated with the other section of the LCU. For example, upon receiving the second section 92, video decoder 30 may reconstruct the missing portion of quadtree 50. To do so, video decoder 30 may identify an index value of a first CU of a received slice. The index value may identify the quadrant to which the sub-CU belongs, thereby providing in indication of a relative position of the sub-CU within the LCU. That is, in the example shown in FIG. 3B, sub-CU 84A may have an index value of 0, sub-CU 84B may have an index value of 1, sub-CU 84C may have an index value of 2, and sub-CU 84D may have an index value of 3. Such index values may be provided as syntax elements in a slice header.

Accordingly, upon receiving the second section 92 video decoder 30 may identify the index value of sub-CU 84C. Video decoder 30 may then use the index value to identify that sub-CU 84C belongs to the lower left quadrant, and that the parent node of sub-CU 84C must include a split flag. That is, because sub-CU 84C is a sub-CU having an index value, the parent CU necessarily includes a split flag.

In addition, video decoder 30 may infer all of the nodes of quadtree 50 included with the second section 92. In an example, video decoder 30 may infer such information using the received portion of quadtree 50 and using a depth-first quadtree traversal algorithm. According to a depth-first traversal algorithm, video decoder 30 expands the first node of the received portion of quadtree 50 until the expanded node has no leaf nodes. Video decoder 30 traverses the expanded node until returning to the most recent node that has not yet been expanded. Video decoder 30 continues in this way until all nodes of the received portion of quadtree 50 have been expanded.

When splitting LCU 80 into different slices, video encoder 20 may also provide other information to assist video decoder 30 in decoding video data. For example, aspects of this disclosure include identifying a relative end of a slice using one or more syntax elements included in a bitstream. In an example, a video encoder, such as video encoder 20, may generate a one bit end of slice flag and provide the end of slice flag with each CU of a frame to indicate whether a particular CU is the final CU of a slice (e.g., the final CU prior to a split). In this example, video encoder 20 may set the end of slice flag to a value of ‘0’ if the CU is positioned at the relative end of the slice and a value of ‘1’ if the CU is positioned at the relative end of the slice. In the example shown in FIG. 3B, sub-CU 84B would include an end of slice flag of ‘1’, while the remaining CUs would include an end of slice flag of ‘0’.

In some examples, video encoder 20 may only provide an end of slice indication (e.g., an end of slice flag) for CUs that are equal to or greater than the granularity used to split a frame into slices. In the example shown in FIG. 3B, video encoder 20 may only provide an end of slice flag with CUs that are equal to or greater than the 16 pixel by 16 pixel granularity, namely, CUs 82A, 82B, 84A-84D, and 86A-86C. In this way, video encoder 20 may achieve a bit savings over an approach in which an end of slice flag is provided with every CU of the frame.

Separate quantization data may also be provided for each slice in examples in which an LCU, such as LCU 80, is split into different slices. For example, as noted above, quantization may be applied according to a quantization parameter (QP) (e.g., which may be identified by a delta QP) that may be defined at the LCU level. According to aspects of this disclosure, however, video encoder 20 may indicate a delta QP value for each portion of an LCU that has been split into different slices. In the example shown in FIG. 3B, video encoder 20 may provide separate delta QPs for the first section 90 and the second section 92, which may be included with the first slice 96 and the second slice 98, respectively.

While certain aspects of FIGS. 3A and 3B are described with respect to video encoder 20 and video decoder 30 for purposes of explanation, it should be understood that other video coding units, such as other processors, processing units, hardware-based coding units including encoder/decoders (CODECs), and the like, may also be configured to perform the examples and techniques described with respect to FIGS. 3A and 3B.

FIG. 4 is a block diagram illustrating an example of video encoder 20 that may implement any or all of the techniques for splitting a frame of video data into independently decodable portions described in this disclosure. In general, video encoder 20 may perform intra- and inter-coding of CUs within video frames. Intra-coding relies on spatial prediction to reduce or remove spatial redundancy in video within a given video frame. Inter-coding relies on temporal prediction to reduce or remove temporal redundancy between a current frame and previously coded frames of a video sequence. Intra-mode (I-mode) may refer to any of several spatial based compression modes and inter-modes such as uni-directional prediction (P-mode) or bi-directional prediction (B-mode) may refer to any of several temporal-based compression modes.

As shown in FIG. 4, video encoder 20 receives a current video block within a video frame to be encoded. In the example of FIG. 4, video encoder 20 includes motion compensation unit 144, motion estimation unit 142, intra-prediction unit 146, reference frame store 164, summer 150, transform unit 152, quantization unit 154, and entropy coding unit 156. Transform unit 152 illustrated in FIG. 4 is the unit that performs the actual transformation, not to be confused with a TU of a CU. For video block reconstruction, video encoder 20 also includes inverse quantization unit 158, inverse transform unit 160, and summer 162. A deblocking filter (not shown in FIG. 4) may also be included to filter block boundaries to remove blockiness artifacts from reconstructed video. If desired, the deblocking filter would typically filter the output of summer 162.

During the encoding process, video encoder 20 receives a video frame or slice to be coded. The frame or slice may be divided into multiple video blocks, e.g., largest coding units (LCUs). Motion estimation unit 142 and motion compensation unit 144 perform inter-predictive coding of the received video block relative to one or more blocks in one or more reference frames to provide temporal compression. Intra-prediction unit 146 may perform intra-predictive coding of the received video block relative to one or more neighboring blocks in the same frame or slice as the block to be coded to provide spatial compression.

Mode select unit 140 may select one of the coding modes, intra or inter, e.g., based on error results versus the number of bits required to signal the video data under each coding mode (e.g., sometimes referred to as rate-distortion), and provides the resulting intra- or inter-coded block to summer 150 to generate residual block data and to summer 162 to reconstruct the encoded block for use in a reference frame. Some video frames may be designated I-frames, where all blocks in an I-frame are encoded in an intra-prediction mode. In some cases, intra-prediction unit 146 may perform intra-prediction encoding of a block in a P- or B-frame, e.g., when motion search performed by motion estimation unit 142 does not result in a sufficient prediction of the block.

In addition to selecting one of the coding modes, according to some examples, video encoder 20 may perform other functions such as determining the granularity at which to split a frame of video data, which may be less than an LCU. For example, video encoder 20 may calculate rate-distortion (e.g., attempting to maximize compression without exceeding a predetermined distortion) for various slice configurations and select a granularity that yields the best result. Video encoder 20 may consider a target slice size when selecting a granularity. For example, as noted above, in some instances it may be desirable to form slices that are of a particular size. One such example may be in preparation to transmit slices over a network. Video encoder 20 may determine a granularity at which to split frames of video data into slices in an attempt to closely match the target size.

In examples in which video encoder 20 determines the granularity at which to split a frame of video data, video encoder 20 may indicate such a granularity. That is, video encoder 20 (such as mode selection unit 140, entropy coding unit 156, or another unit of video encoder 20) may provide an indication of the granularity to assist a video decoder in decoding the video data. For example, video encoder 20 may identify the granularity according to a CU depth at which the split may occur.

For purposes of explanation, assume a frame of video data has one or more LCUs that are 128 pixels by 128 pixels in size. In this example, video encoder 20 may determine that the frame may be split into slices at a granularity of 32 pixels by 32 pixels, for example, in order to achieve a target slice size. Video encoder 20 may indicate such a granularity according to a hierarchical depth at which the slice split may occur. That is, according to the hierarchical quadtree arrangement show in FIGS. 3A and 3B, the 32 pixel by 32 pixel sub-CU has a CU depth of two. Accordingly, in this example, video encoder 20 may signal the slice granularity by indicating that the slice split may occur at a CU depth of two.

In an example, video encoder 20 may provide an indication of the granularity at which a frame of video data may be split into slices in a picture parameter set (PPS). For example, by way of background, video encoder 20 may format compressed video data for transmission via a network into so-called “network abstraction layer units” or NAL units. Each NAL unit may include a header that identifies a type of data stored to the NAL unit. There are two types of data that are commonly stored to NAL units. The first type of data stored to a NAL unit is video coding layer (VCL) data, which includes the compressed video data. The second type of data stored to a NAL unit is referred to as non-VCL data, which includes additional information such as parameter sets that define header data common to a large number of NAL units and supplemental enhancement information (SEI). For example, parameter sets may contain the sequence-level header information (e.g., in sequence parameter sets (SPS)) and the infrequently changing picture-level header information (e.g., in picture parameter sets (PPS)). The infrequently changing information contained in the parameter sets does not need to be repeated for each sequence or picture, thereby improving coding efficiency. In addition, the use of parameter sets enables out-of-band transmission of header information, thereby avoiding the need of redundant transmissions for error resilience.

In one example, an indication of the granularity at which a frame of video data may be split into slices may be indicated according to Table 1 below:

TABLE 1
pic_parameter_set_rbsp( )

| pic_parameter_set_rbsp( ) { | C | Descriptor |
|---|---|---|
| pic_parameter_set_id | 1 | ue(v) |
| seq_parameter_set_id | 1 | ue(v) |
| entropy_coding_mode_flag | 1 | u(1) |
| num_ref_idx_l0_default_active_minus1 | 1 | ue(v) |
| num_ref_idx_l1_default_active_minus1 | 1 | ue(v) |
| pic_init_qp_minus26 /* relative to 26 */ | 1 | se(v) |
| slice_granu_CU_depth | 1 | ue(v) |
| constrained_intra_pred_flag | 1 | u(1) |
| for(i=0;i<15; i++){ | | |
| numAllowedFilters[i] | 1 | ue(v) |
| for(j=0;j<numAllowedFilters;j++){ | | |
| filtIdx[i][j] | 1 | ue(v) |
| } | | |
| } | | |
| rbsp_trailing_bits( ) | 1 | |
| } | | |

In the example shown in Table 1, slice_granu_CU_depth may specify the granularity used to split a frame of video data into slices. For example, slice_granu_CU_depth may specify the CU depth as a granularity used to split the frame into slices by identifying a hierarchical depth at which the slice split may occur compared to an LCU (e.g., LCU=depth 0). According to aspects of this disclosure, a slice may contain a series of LCUs (e.g., including all CUs in the associated hierarchical quadtree structure) and an incomplete LCU. An incomplete LCU may contain one or more complete CUs with a size as small as max_coding_unit_width>>slice_granu_CU_depth by max_coding_unit_height>>slice_granu_CU_depth, but not smaller. For example, a slice cannot contain a CU having a size that is less than max_coding_unit_width>>slice_granu_CU_depth by max_coding_unit_height>>slice_granu_CU_depth and that does not belong to an LCU that is fully contained in the slice. That is, a slice boundary may not occur within a CU that is equal or smaller than the CU size of max_coding_unit_width>>slice_granu_CU_depth by max_coding_unit_height>>slice_granu_CU_depth.

In examples in which video encoder 20 determines a granularity that is smaller than an LCU for splitting a frame of video data into slices, video encoder 20 may separate hierarchical quadtree information for an LCU being split into different slices and present the separated portions of the quadtree information with each slice. For example, as described above with respect to FIGS. 3A and 3B, video encoder 20 may separate split flags associated with each section of an LCU being split between slices. Video encoder 20 may then provide the split flags associated with a first section of the split LCU with a first slice and the split flags associated with the other section of the split LCU with a second slice. In this way, if the first slice is corrupted or lost, a video decoder may still be able to properly decode the remaining portion of the LCU that is included with the second slice.

Additionally or alternatively, video encoder 20 may identify a relative end of a slice using one or more syntax elements. For example, video encoder 20 may generate a one bit end of slice flag and provide the end of slice flag with each CU of a frame to indicate whether a particular CU is the final CU of a slice (e.g., the final CU prior to a split). For example, video encoder 20 may set the end of slice flag to a value of ‘0’ if the CU is positioned at the relative end of the slice and a value of ‘1’ if the CU is positioned at the relative end of the slice.

In some examples, video encoder 20 may only provide an end of slice indication (e.g., an end of slice flag) for CUs that are equal to or greater than the granularity used to split a frame into slices. For example, assume for purposes of explanation that video encoder 20 determines the granularity at which to split a frame of video data into slices is 32 pixels by 32 pixels, with an LCU size of 64 pixels by 64 pixels. In this example, mode selection unit 140 may only provide an end of slice flag with CUs that are 32 pixels by 32 pixels or greater in size.

In an example, video encoder 20 may generate an end of slice flag according to Table 2 shown below:

TABLE 2
coding_tree(x0, y0, log2CUSize)

| coding_tree( x0, y0, log2CUSize ) { | Descriptor |
|---|---|
| if( x0 + ( 1 << log2CUSize ) <= PicWidthInSamples_{L} && | |
| y0 + ( 1 << log2CUSize ) <= PicHeightInSamples_{L} && | |
| log2CUSize > Log2MinCUSize && | |
| cuAddress(x0 ,y0) >= sliceAddress ) | |
| split_coding_unit_flag[ x0 ][ y0 ] | u(1)\|ae(v) |
| if( adaptive_loop_filter_flag && alf_cu_control_flag ) | |
| { | |
| cuDepth = Log2MaxCUSize − log2CUSize | |
| if( cuDepth <= alf_cu_control_max_depth ) | |
| if( cuDepth == alf_cu_control_max_depth \|\| | |
| split_coding_unit_flag[ x0 ][ y0 ] == 0 ) | |
| AlfCuFlagIdx++ | |
| } | |
| if( split_coding_unit_flag[ x0 ][ y0 ] ) { | |
| x1 = x0 + ( ( 1 << log2CUSize ) >> 1 ) | |
| y1 = y0 + ( ( 1 << log2CUSize ) >> 1 ) | |
| if( cuAddress(x1,y0) > sliceAddress ) | |
| moreDataFlag = coding_tree( x0, y0 | |
| log2CUSize − 1 ) | |
| if(cuAddress(x0,y1) > sliceAddress && moreDataFlag | |
| && x1 < PicWidthInSamples_{L} ) | |
| moreDataFlag = coding_tree( x1, y0, | |
| log2CUSize − 1 ) | |
| if(cuAddress(x1,y1) > sliceAddress && moreDataFlag | |
| && y1 < PicHeightInSamples_{L} ) { | |
| moreDataFlag = coding_tree( x0, y1, | |
| log2CUSize − 1 ) | |
| if( moreDataFlag && x1 < PicWidthInSamples_{L} && y1 | |
| < PicHeightInSamples_{L} ) | |
| moreDataFlag = coding_tree( x1, y1, | |
| log2CUSize − 1 ) | |
| } else { | |
| if(adaptive_loop_filter_flag && alf_cu_control_flag ) | |
| AlfCuFlag[ x0 ][ y0 ] = alf_cu_flag[ AlfCuFlagIdx ] | |
| coding_unit( x0, y0, log2CUSize ) | |
| if( !entropy_coding_mode_flag ) | |
| moreDataFlag = more_rbsp_data( ) | |
| else { | |
| if( log2CUsize >= (Log2MaxCUSize − | |
| slice_granu_CU_depth){ | |
| end_of_slice_flag | ae(v) |
| moreDataFlag = !end_of_slice_flag | |
| } | |
| else | |
| { | |
| moreDataFlag = 1; | |
| } | |
| } | |
| } | |
| return moreDataFlag | |
| } | |

While certain aspects of this disclosure have been generally described with respect to video encoder 20, is should be understood that such aspects may be carried out by one or more units of video encoder 20 such as mode selection unit 140 or one or more other units of video encoder 20.

Motion estimation unit 142 and motion compensation unit 144 may be highly integrated, but are illustrated separately for conceptual purposes. Motion estimation is the process of generating motion vectors, which estimate motion for video blocks, for inter-coding. A motion vector, for example, may indicate the displacement of a prediction unit in a current frame relative to a reference sample of a reference frame. A reference sample is a block that is found to closely match the portion of the CU including the PU being coded in terms of pixel difference, which may be determined by sum of absolute difference (SAD), sum of square difference (SSD), or other difference metrics. Motion compensation, performed by motion compensation unit 144, may involve fetching or generating values for the prediction unit based on the motion vector determined by motion estimation. Again, motion estimation unit 142 and motion compensation unit 144 may be functionally integrated, in some examples.

Motion estimation unit 142 calculates a motion vector for a prediction unit of an inter-coded frame by comparing the prediction unit to reference samples of a reference frame stored in reference frame store 164. In some examples, video encoder 20 may calculate values for sub-integer pixel positions of reference frames stored in reference frame store 164. For example, video encoder 20 may calculate values of one-quarter pixel positions, one-eighth pixel positions, or other fractional pixel positions of the reference frame. Therefore, motion estimation unit 142 may perform a motion search relative to the full pixel positions and fractional pixel positions and output a motion vector with fractional pixel precision. Motion estimation unit 142 sends the calculated motion vector to entropy coding unit 156 and motion compensation unit 144. The portion of the reference frame identified by a motion vector may be referred to as a reference sample. Motion compensation unit 144 may calculate a prediction value for a prediction unit of a current CU, e.g., by retrieving the reference sample identified by a motion vector for the PU.

Intra-prediction unit 146 may perform intra-prediction for coding the received block, as an alternative to inter-prediction performed by motion estimation unit 142 and motion compensation unit 144. Intra-prediction unit 146 may encode the received block relative to neighboring, previously coded blocks, e.g., blocks above, above and to the right, above and to the left, or to the left of the current block, assuming a left-to-right, top-to-bottom encoding order for blocks. Intra-prediction unit 146 may be configured with a variety of different intra-prediction modes. For example, intra-prediction unit 146 may be configured with a certain number of prediction modes, e.g., 35 prediction modes, based on the size of the CU being encoded.

Intra-prediction unit 146 may select an intra-prediction mode from the available intra-prediction modes by, for example, calculating rate-distortion (e.g., attempting to maximize compression without exceeding a predetermined distortion) for various intra-prediction modes and selecting a mode that yields the best result. Intra-prediction modes may include functions for combining values of spatially neighboring pixels and applying the combined values to one or more pixel positions in a predictive block that is used to predict a PU. Once values for all pixel positions in the predictive block have been calculated, intra-prediction unit 146 may calculate an error value for the prediction mode based on pixel differences between the PU and the predictive block. Intra-prediction unit 146 may continue testing intra-prediction modes until an intra-prediction mode that yields an acceptable error value versus bits required to signal the video data is discovered. Intra-prediction unit 146 may then send the PU to summer 150.

Video encoder 20 forms a residual block by subtracting the prediction data calculated by motion compensation unit 144 or intra-prediction unit 146 from the original video block being coded. Summer 150 represents the component or components that perform this subtraction operation. The residual block may correspond to a two-dimensional matrix of values, where the number of values in the residual block is the same as the number of pixels in the PU corresponding to the residual block. The values in the residual block may correspond to the differences between collocated pixels in a predictive block and in the original block to be coded.

Transform unit 152 applies a transform, such as a discrete cosine transform (DCT), integer transform, or a conceptually similar transform, to the residual block, producing a video block comprising residual transform coefficient values. Transform unit 152 may perform other transforms, such as those defined by the H.264 standard, which are conceptually similar to DCT. Wavelet transforms, integer transforms, sub-band transforms or other types of transforms could also be used. In any case, transform unit 152 applies the transform to the residual block, producing a block of residual transform coefficients. Transform unit 152 may convert the residual information from a pixel value domain to a transform domain, such as a frequency domain.

Quantization unit 154 quantizes the residual transform coefficients to further reduce bit rate. The quantization process may reduce the bit depth associated with some or all of the coefficients. The degree of quantization may be modified by adjusting a quantization parameter (QP). In some examples, the QP may be defined at the LCU level. Accordingly, the same level of quantization may be applied to all transform coefficients in the TUs associated with different PUs of CUs within an LCU. However, rather than signal the QP itself, a change (i.e., a delta) in the QP may be signaled with the LCU. The delta QP defines a change in the quantization parameter for the LCU relative to some reference QP, such as the QP of a previously communicated LCU.

In examples in which an LCU is divided between two slices, in accordance with aspects of this disclosure, quantization unit 154 may define separate QPs (or delta QPs) for each portion of the divided LCU. For purposes of explanation, assume an LCU is split between two slices, such that a first section of the LCU is included with a first slice and a second section of the LCU is included with a second slice. In this example, quantization unit 154 may define a first delta QP for the first section of the LCU and a second delta QP, separate from the first delta QP, for the second section of the LCU. In some examples, the delta QP provided with the first slice may be different than the delta QP provided with the second slice.

In an example, quantization unit 154 may provide an indication of delta QP values according to Table 3 shown below:

TABLE 3
coding_unit(x0, y0, currCodingUnitSize)

| coding_unit( x0, y0, currCodingUnitSize ) { | C | Descriptor |
|---|---|---|
| if (firstCUFlag \|\| currCodingUnitSize | | |
| >=MinQPCodingUnitSize) { | | |
| cu_QP_delta; | 2 | u(1)\|e(v) |
| firstCUFlag = false; | | |
| } | | |
| if( x0+currCodingUnitSize < PicWidthInSamples_{L} && | | |
| y0+currCodingUnitSize < PicHeightInSamples_{L} && | | |
| currCodingUnitSize > MinCodingUnitSize ) | | |
| split_coding_unit_flag | 2 | u(1)\|ae(v) |
| if( split_coding_unit_flag ) { | | |
| splitCodingUnitSize = currCodingUnitSize >> 1 | | |
| x1 = x0 + splitCodingUnitSize | | |
| y1 = y0 + splitCodingUnitSize | | |
| coding_unit( x0, y0, splitCodingUnitSize ) | 2\|3\|4 | |
| if( x1 < PicWidthInSamples_{L} ) | | |
| coding_unit( x1, y0, splitCodingUnitSize ) | 2\|3\|4 | |
| if( y1 < PicHeightInSamples_{L} ) | | |
| coding_unit( x0, y1, splitCodingUnitSize ) | 2\|3\|4 | |
| if( x1 < PicWidthInSamples_{L} && y1 < | | |
| PicHeightInSamples_{L} ) | | |
| coding_unit( x1, y1, splitCodingUnitSize ) | 2\|3\|4 | |
| } else { | | |
| prediction_unit( x0, y0, currCodingUnitSize ) | 2 | |
| if( PredMode != MODE_SKIP \|\| !(PredMode == | | |
| MODE_INTRA && planar_flag == 1) ) | | |
| if( entropy_coding_mode_flag ) { | | |
| transform_unit_tree( x0, y0, currCodingUnitSize, 0 ) | 3\|4 | |
| transform_unit_coeff( x0, y0, currCodingUnitSize, 0, | 3\|4 | |
| 0 ) | | |
| transform_unit_coeff( x0, y0, currCodingUnitSize, 0, | 3\|4 | |
| 1 ) | | |
| transform_unit_coeff( x0, y0, currCodingUnitSize, 0, | 3\|4 | |
| 2 ) | | |
| } else | | |
| transform_unit_vlc( x0, y0, currCodingUnitSize ) | 3\|4 | |
| } | | |
| } | | |

In the example of Table 2, cu_QP_delta can change the value of QP_{Y} in the CU layer. That is, a separate cu_QP_delta value may be defined for two different sections of an LCU that has been split into different slices. According to some examples, a decoded value of cu_QP_delta may be in the range of −26 to +25. If a cu_QP_delta value is not provided for a CU, a video decoder may infer the cu_QP_delta value to be equal to zero.

In some examples, a QP_{Y} value may be derived according to Equation (1) below, where QP_{Y,PREV} is the luma quantization parameter (QP_{Y}) of the previous CU in a decoding order in of a current slice.

QP_{Y}=(QP_{Y,PREV}+cu_{—}qp_delta+52)% 52 (1)

In addition, for a first CU in of a slice, the QP_{Y, PREV} value may initially be set equal to SliceQP_{Y}, which may be the initial QP_{Y} that is used for all blocks of the slice until the quantization parameter is modified. Moreover, a firstCUFlag may be set to ‘true’ at the start of each slice.

According to some aspects of this disclosure, quantization unit 154 may determine a minimum CU size that may be assigned a QP_{Y} value. For example, quantization unit 154 may only set a QP value for CUs that are equal to or larger than a MinQPCodingUnitSize. In some examples, when MinQPCodingUnitSize is equal to the MaxCodingUnitSize (e.g., the size of the maximum supported CU (LCU)), quantization unit 154 may only signal a QP value for LCUs and a first CU in a slice. In another example, instead of only signaling a delta QP value for the first CU of a slice and/or the LCU, the quantization unit 154 may signal the minimum QP CU size that a delta QP may be set, which may be fixed for a particular sequence (e.g., sequence of frames). For example, the quantization unit 154 may signal the minimum QP CU size, for example, in a parameter set such as a picture parameter set (PPS) or sequence parameter set (SPS).

In another example, quantization unit 154 may identify the minimum CU size that may be assigned a QP value according to CU depth. That is, quantization unit 154 may only set a QP value for CUs that are positioned equal to or higher than (e.g., relatively higher on a quadtree structure) than a MinQPCUDepth. In this example, the MinQPCodingUnitSize can be dereived based on MinQPCUDepth and the MaxCodingUnitSize. The minimum QP depth may be signaled, for example, in a parameter set such as a PPS or SPS.

Following quantization, entropy coding unit 156 entropy codes the quantized transform coefficients. For example, entropy coding unit 156 may perform content adaptive variable length coding (CAVLC), context adaptive binary arithmetic coding (CABAC), or another entropy coding technique. Following the entropy coding by entropy coding unit 156, the encoded video may be transmitted to another device or archived for later transmission or retrieval. In the case of context adaptive binary arithmetic coding (CABAC), context may be based on neighboring coding units.

In some cases, entropy coding unit 156 or another unit of video encoder 20 may be configured to perform other coding functions, in addition to entropy coding. For example, entropy coding unit 156 may be configured to determine the CBP values for the coding unit and partitions. Also, in some cases, entropy coding unit 156 may perform run length coding of the coefficients in a coding unit or partition thereof. In particular, entropy coding unit 156 may apply a zig-zag scan or other scan pattern to scan the transform coefficients in a coding unit or partition and encode runs of zeros for further compression. Entropy coding unit 156 also may construct header information with appropriate syntax elements for transmission in the encoded video bitstream.

In examples in which entropy coding unit 156 constructs header information for slices, according to aspects of this disclosure, entropy coding unit 156 may determine a set of pervasive slice parameters. The pervasive slice parameters may, for example, include syntax elements common to two or more slices. As noted above, the syntax elements may assist a decoder in decoding the slices. In some examples the pervasive slice parameters may be referred to herein as a “frame parameter set” (FPS). According to aspects of this disclosure, an FPS may be applied to multiple slices. An FPS may refer to a picture parameter set (PPS) and a slice header may refer to an FPS.

In general, an FPS may contain most of the information of a typical slice header. The FPS, however, need not be repeated for each slice. According to some examples, entropy coding unit 156 may generate header information that references an FPS. The header information may include, for example, a frame parameter set identifier (ID) that identifies the FPS. In some instances, entropy coding unit 156 may define a plurality of FPSs, where each of the plurality of FPSs is associated with a different frame parameter set identifier. Entropy coding unit 156 may then generate slice header information that identifies the pertinent one of the plurality of the FPSs.

In some instances, entropy coding unit 156 may only identify an FPS if the identified FPS is different from the FPS associated with a previously decoded slice of the same frame. Entropy coding unit 156, in these instances, may define a flag in each slice header that identifies whether the FPS identifier is set. If such a flag is not set (e.g., the flag has a value of ‘0’), the FPS identifier from a previously decoded slice of the frame may be reused for the current slice. Using an FPS identifier flag in this way may further reduce the amount of bits consumed by the slice header, especially when a large number of FPSs are defined.

In an example, entropy coding unit 156 may generate an FPS according to Table 4, as shown below:

TABLE 4
fra_parameter_set_header( )

| fra_parameter_set_header( ) { | C | Descriptor |
|---|---|---|
| slice_type | 2 | ue(v) |
| pic_parameter_set_id | 2 | ue(v) |
| fra_parameter_set_id | 2 | ue(v) |
| frame_num | 2 | u(v) |
| if( IdrPicFlag ) | | |
| idr_pic_id | 2 | ue(v) |
| pic_order_cnt_lsb | 2 | u(v) |
| if( slice_type = = P \| \| slice_type = = B ) { | | |
| num_ref_idx_active_override_flag | 2 | u(1) |
| if( num_ref_idx_active_override_flag ) { | | |
| num_ref_idx_l0_active_minus1 | 2 | ue(v) |
| if( slice_type = = B ) | | |
| num_ref_idx_l1_active_minus1 | 2 | ue(v) |
| } | | |
| } | | |
| ref_pic_list_modification( ) | | |
| if( nal_ref_idc != 0 ) | | |
| dec_ref_pic_marking( ) | 2 | |
| if( entropy_coding_mode_flag ) { | | |
| pipe_multi_codeword_flag | 2 | u(1) |
| if( !pipe_multi_codeword_flag ) | | |
| pipe_max_delay_shift_6 | 2 | ue(v) |
| else | | |
| balanced_cpus | 2 | u(8) |
| if( slice_type != I ) | | |
| cabac_init_idc | 2 | ue(v) |
| } | | |
| slice_qp_delta | 2 | se(v) |
| alf_param( ) | | |
| if( slice_type = = P \| \| slice_type = = B ) { | | |
| mc_interpolation_idc | 2 | ue(v) |
| mv_competition_flag | 2 | u(1) |
| if ( mv_competition_flag ) { | | |
| mv_competition_temporal_flag | 2 | u(1) |
| } | | |
| } | | |
| if ( slice_type = = B && mv_competition_flag) | | |
| collocated_from_l0_flag | 2 | u(1) |
| sifo_param( ) | | |
| edge_based_prediction_flag | 2 | u(1) |
| if( edge_prediction_ipd_flag = = 1 ) | | |
| threshold_edge | 2 | u(8) |
| } | | |

The semantics associated with the syntax elements included in the example of Table 4 above are the same as the emerging HEVC standard, however, the semantics are applicable to all slices that refer to this FPS header. That is, for example, fra_parameter_set_id indicates the identifier of the frame parameter set header. Accordingly, one or more slices that share the same header information may refer to the FPS identifier. Two FPS headers are identical if the headers have identical fra_parameter_set_id, frame_num, and picture order count (POC).

According to some examples, an FPS header may be contained in the picture parameter set (PPS) raw byte sequence payload (RBSP). In an example, an FPS header may be contained in the PPS according to Table 5, shown below:

TABLE 5
pic_parameter_set_rbsp( )

| pic_parameter_set_rbsp( ) { | C | Descriptor |
|---|---|---|
| pic_parameter_set_id | 1 | ue(v) |
| ... | | |
| num_fps_headers | 1 | ue(v) |
| for (i =0; i < num_fps_headers; i++ ) | | |
| fra_parameter_set_header( ) | | |
| rbsp_trailing_bits( ) | 1 | |
| } | | |

According to some examples, an FPS header may be contained in one or more slices of a frame. In an example, an FPS header may be contained in one or more slices of a frame according to Table 6, shown below:

TABLE 6
slice_header( )

| slice_header( ) { | C | Descriptor |
|---|---|---|
| first_lctb_in_slice | 2 | ue(v) |
| fps_present_flag | 2 | u(1) |
| if ( fps_present_flag ) | | |
| fra_parameter_set_header( ) | | |
| else | | |
| fra_parameter_set_id | 2 | ue(v) |
| end_picture_flag | 2 | u(1) |
| ... | | |

In the example of Table 6, fps_present_flag may indicate whether a slice header for a current slice contains a FPS header. In addition, fra_parameter_set_id may specify the identifier of the FPS header that the current slice refers to. In addition, according to the example shown in Table 6, end_picture_flag indicates whether the current slice is the last slice of the current picture.

While certain aspects of this disclosure (e.g., such as generating header syntax and/or parameter sets) have been described with respect to entropy coding unit 156, it should be understood that such description has been provided for purposes of explanation only. That is, in other examples, a variety of other coding modules may be used to generate header data and/or parameter sets. For example, header data and/or parameter sets may be generated by fixed length coding module (e.g., uuencoding (UUE) or other coding method).

Referring still to FIG. 4, inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame store 64. Motion compensation unit 44 may also apply one or more interpolation filters to the reconstructed residual block to calculate sub-integer pixel values for use in motion estimation. Summer 162 adds the reconstructed residual block to the motion compensated prediction block produced by motion compensation unit 44 to produce a reconstructed video block for storage in reference frame store 64. The reconstructed video block may be used by motion estimation unit 42 and motion compensation unit 44 as a reference block to inter-code a block in a subsequent video frame.

Techniques of this disclosure also relate to defining a profile and/or one or more levels for controlling the finest slice granularity the sequence can use. For example, as with most video coding standards, H.264/AVC defines the syntax, semantics, and decoding process for error-free bitstreams, any of which conform to a certain profile or level. H.264/AVC does not specify the encoder, but the encoder is tasked with guaranteeing that the generated bitstreams are standard-compliant for a decoder. In the context of video coding standard, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and macroblock (MB) processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder, such as video decoder 30, conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define, for example, limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

Aspects of this disclosure relate to defining a profile for controlling the extent to which slice granularity may be modified. That is, video encoder 20 may utilize a profile to disable the ability to split a frame of video data into slices at a granularity that is smaller than a certain CU depth. In some examples, a profile may not support slice granularity to a CU depth that is lower than an LCU depth. In such examples, slices in a coded video sequence may be LCU aligned (e.g., each slice contains one or more fully formed LCUs).

In addition, as noted above, the slice granularity may be signaled in the sequence level, e.g., in the sequence parameter set. In such examples, the slice granularity signaled for pictures (e.g., signaled in a picture parameter set), are generally equal to or larger than the slice granularity indicated in the sequence parameter set. For example, if a slice granularity is 8×8, three picture parameter sets might be conveyed in the bitstream, with each of the picture parameter setshaving different slice granularities (e.g., 8×8, 16×16 and 32×32). In this example, slices in a particular sequence may refer to any of the picture parameter sets, and thus the granularity may be 8×8, 16×16 or 32×32 (e.g., but not 4×4 or smaller).

Aspects of this disclosure also relate to defining one or more levels. For example, one or more levels might indicate that the decoder implementation conforming to that level supports a certain slice granularity level. That is, a particular level may have a slice granularity corresponding to CU size of 32×32, while a higher level may have the slice granularity corresponding to CU size of 16×16, and another higher level may allow for a relatively smaller slice granularity (e.g., a granularity of 8×8 pixels).

As shown in Table 7, different levels of a decoder may have different constraint on to which extend of CU size the slice granularity can be.

TABLE 7
Profiles and Levels

| | Max | | Max number of | |
|---|---|---|---|---|
| | macroblock | Min | motion vectors | |
| | processing rate | compression | per two | Smallest |
| Level | MaxMBPS | ratio | consecutive MBs | slice |
| number | (MB/s) | MinCR | MaxMvsPer2 Mb | granularity |
| 3.2 | 216 000 | 4 | 16 | 64 × 64 |
| 4 | 245 760 | 4 | 16 | 32 × 32 |
| 4.1 | 245 760 | 2 | 16 | 16 × 16 |
| 4.2 | 491 520 | 2 | 16 | 8 × 8 |
| 5 | 589 824 | 2 | 16 | |
| 5.1 | 983 040 | 2 | 16 | |

In the example of FIG. 4, certain aspects of this disclosure, e.g., aspects related to splitting a frame of video data into slices at a granularity smaller than an LCU, have been described with respect to specific units of video encoder 20. It should be understood, however, that the functional units provided in the example of FIG. 4 are provided for purposes of explanation. That is, certain units of video encoder 20 may be shown and described separately for purposes of explanation, but may be highly integrated, such as, for example, within an integrated circuit or other processing unit. Accordingly, functions ascribed to one unit of video encoder 20 may be performed by one or more other units of video encoder 20.

In this manner, video encoder 20 is an example of a video encoder that may encode a frame of video data comprising a plurality of block-sized coding units including one or more largest coding units (LCUs) that include a hierarchically arranged plurality of relatively smaller coding units. According to an example, video encoder 20 may determine a granularity at which the hierarchically arranged plurality of smaller coding units is to be split when forming independently decodable portions of the frame. Video encoder 20 may split an LCU using the determined granularity to generate a first section of the LCU and a second section of the LCU, and generate an independently decodable portion of the frame to include the first section of the LCU without including the second section of the LCU. Video encoder 20 may also generate a bitstream to include the independently decodable portion of the frame and an indication of the determined granularity.

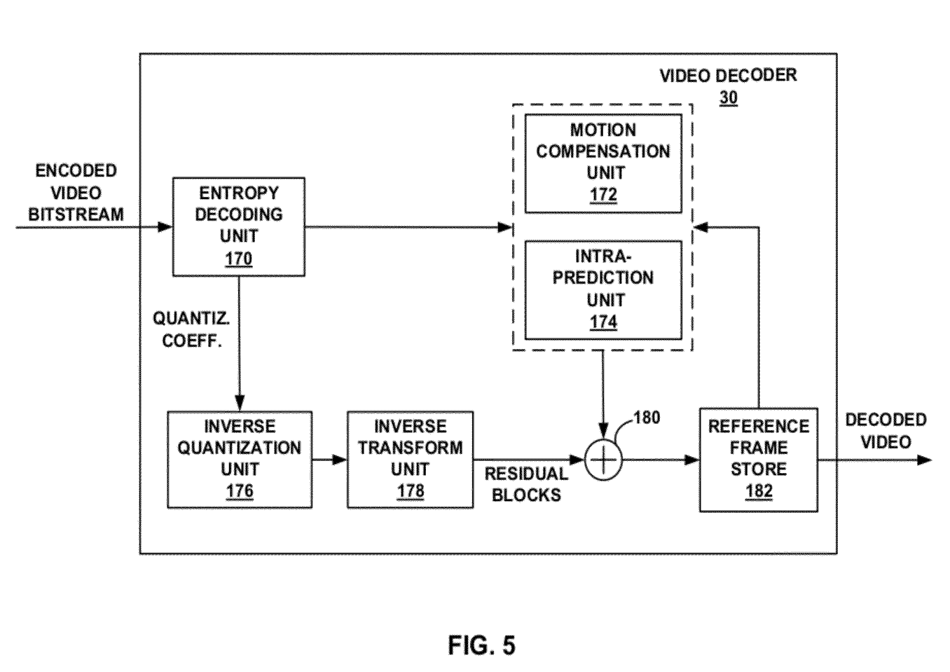

FIG. 5 is a block diagram illustrating an example of video decoder 30 that may implement any or all of the techniques for decoding a frame of video data that has been split into independently decodable portions described in this disclosure. That is, for example, video decoder 30 may be configured to decode any syntax, parameter sets, header data, or other data described with respect to video encoder 20 associated with decoding a frame of video data that has been split into independently decodable portions.

In the example of FIG. 5, video decoder 30 includes an entropy decoding unit 170, motion compensation unit 172, intra-prediction unit 174, inverse quantization unit 176, inverse transformation unit 178, reference frame store 182 and summer 180. It should be understood, as noted with respect to FIG. 4 above, that the units described with respect to video decoder 30 may be highly integrated, but described separately for purposes of explanation.

A video sequence received at video decoder 30 may comprise an encoded set of image frames, a set of frame slices, a commonly coded group of pictures (GOPs), or a wide variety of units of video information that include encoded LCUs and syntax information that provides instructions regarding how to decode such LCUs. Video decoder 30 may, in some examples, perform a decoding pass generally reciprocal to the encoding pass described with respect to video encoder 20 (FIG. 4). For example, entropy decoding unit 170 may perform the reciprocal decoding function of the encoding performed by entropy encoding unit 156 of FIG. 4. In particular, entropy decoding unit 170 may perform CAVLC or CABAC decoding, or any other type of entropy decoding used by video encoder 20.

In addition, according to aspects of this disclosure, entropy decoding unit 170, or another module of video decoder 30, such as a parsing module, may use syntax information (e.g., as provided by a received quadtree) to determine sizes of LCUs used to encode frame(s) of the encoded video sequence, split information that describes how each CU of a frame of the encoded video sequence is split (and likewise, how sub-CUs are split), modes indicating how each split is encoded (e.g., intra- or inter-prediction, and for intra-prediction an intra-prediction encoding mode), one or more reference frames (and/or reference lists containing identifiers for the reference frames) for each inter-encoded PU, and other information to decode the encoded video sequence.

In examples in which a frame of video data has been split into slices at a granularity smaller than an LCU, in accordance with the techniques of this disclosure, video decoder 30 may be configured to identify such a granularity. That is, for example, video decoder 30 may determine the granularity at which a frame of video data has been split according to a received or signaled granularity value. In some examples, as described above with respect to video encoder 20, the granularity may be identified according to a CU depth at which a slice split may occur. The CU depth value may be included in the received syntax of a parameter set, such as a picture parameter set (PPS). For example, an indication of the granularity at which a frame of video data may be split into slices may be indicated according to Table 1, as described above.

In addition, video decoder 30 may determine an address at which the slice begins (e.g., a “slice address”). The slice address may indicate a relative position at which a slice begins within a frame. The slice address may be provided at the slice granularity level. In some examples, the slice address may be provided in a slice header. In a particular example, a slice_address syntax element may specify the address in slice granularity resolution in which a slice begins. In this example, slice_address may be represented by (Ceil(Log 2(NumLCUsInPicture))+SliceGranularity) bits in the bitstream where NumLCUsInPicture is the number of LCUs in a picture (or frame). The variable LCUAddress may be set to (slice_address>>SliceGranularity) and may represent the LCU part of the slice address in raster scan order. The variable GranularityAddress may be set to (slice_address−(LCUAddress<<SliceGranularity)) and may represent the sub-LCU part of the slice address expressed in z-scan order. The variable SliceAddress may then be set to (LCUAddress<<(log 2_diff_max_min_coding_block_size<<1))+(GranularityAddress<<((log 2_diff_max_min_coding_block_size<<1)−SliceGranularity) and the slice decoding may start with the largest coding unit possible at the slice starting coordinate.

In addition, to identify a location in which a slice split has occurred, video decoder 30 may be configured to receive one or more syntax elements identifying the relative end of a slice. For example, video decoder 30 may be configured to receive a one bit end of slice flag included with each CU of a frame that indicates whether the CU being decoded is the final CU of a slice (e.g., the final CU prior to a split). In some examples, video decoder 30 may only receive an end of slice indication (e.g., an end of slice flag) for CUs that are equal to or greater than the granularity used to split a frame into slices.

In addition, video decoder 30 may be configured to receive separate hierarchical quadtree information for an LCU that has been split into different slices. For example, video decoder 30 may receive separated split flags associated with different sections of an LCU that has been split between slices.

In some examples, in order to properly decode a current section of an LCU that contains only a portion of the quadtree information for the LCU, video decoder 30 may reconstruct the quadtree information associated with a previous section of the LCU. For example, as described with respect to FIGS. 3A and 3B above, video decoder 30 may identify an index value of a first sub-CU of a received slice. Video decoder 30 may then use the index value to identify the quadrant to which the received sub-CU belongs. In addition, video decoder 30 may infer all of the nodes of the quadtree of the received section of the LCU (e.g., using a depth-first quadtree traversal algorithm and received split flags, as described above).

As noted above with respect to video encoder 20 (FIG. 4), aspects of this disclosure also relate to defining one or more profiles and/or levels for controlling the granularity at which a frame of video data may be split into slices. Accordingly, in some examples, video decoder 30 may be configured to utilize such profiles and/or levels described with respect to FIG. 4. Moreover, video decoder 30 may be configured to receive and utilize any frame parameter sets (FPSs) defined by video encoder 20.

While certain aspects of this disclosure have been generally described with respect to video decoder 30, is should be understood that such aspects may be carried out by one or more units of video decoder 30 such as entropy decoding unit 170, a parsing module, or one or more other units of video decoder 30.

Motion compensation unit 172 may generate prediction data based on motion vectors received from entropy decoding unit 170. For example, motion compensation unit 172 produces motion compensated blocks, possibly performing interpolation based on interpolation filters. Identifiers for interpolation filters to be used for motion estimation with sub-pixel precision may be included in syntax elements. Motion compensation unit 172 may use interpolation filters as used by video encoder 20 during encoding of the video block to calculate interpolated values for sub-integer pixels of a reference block. Motion compensation unit 172 may determine the interpolation filters used by video encoder 20 according to received syntax information and use the interpolation filters to produce predictive blocks.

Intra-prediction unit 174 may generate prediction data for a current block of a current frame based on a signaled intra-prediction mode and data from previously decoded blocks of the current frame.

In some examples, inverse quantization unit 176 may scan received values using a scan mirroring that used by video encoder 20. In this manner, video decoder 30 may produce a two-dimensional matrix of quantized transform coefficients from a received, one dimensional array of coefficients. Inverse quantization unit 176 inverse quantizes, i.e., de-quantizes, the quantized transform coefficients provided in the bitstream and decoded by entropy decoding unit 170.

The inverse quantization process may include a conventional process, e.g., as defined by the H.264 decoding standard or by HEVC. The inverse quantization process may include use of a quantization parameter (QP) or delta QP calculated and signaled by video encoder 20 for the CU to determine a degree of quantization and, likewise, a degree of inverse quantization that should be applied.

In examples in which an LCU is divided between two slices, in accordance with aspects of this disclosure, inverse quantization unit 176 may receive separate QPs (or delta QPs) for each portion of the divided LCU. For purposes of explanation, assume an LCU has been split between two slices, such that a first section of the LCU has been included with a first slice and a second section of the LCU has been included with a second slice. In this example, inverse quantization unit 176 may receive a first delta QP for the first section of the LCU and a second delta QP, separate from the first delta QP, for the second section of the LCU. In some examples, the delta QP provided with the first slice may be different than the delta QP provided with the second slice.

Inverse transform unit 178 applies an inverse transform, e.g., an inverse DCT, an inverse integer transform, an inverse rotational transform, or an inverse directional transform. Summer 180 combines the residual blocks with the corresponding predictive blocks generated by motion compensation unit 72 or intra-prediction unit 74 to form decoded blocks. If desired, a deblocking filter may also be applied to filter the decoded blocks in order to remove blockiness artifacts. The decoded video blocks are then stored in reference frame store 82, which provides reference blocks for subsequent motion compensation and also produces decoded video for presentation on a display device (such as display device 32 of FIG. 1).

In the example of FIG. 5, certain aspects of this disclosure, e.g., aspects related to receiving and decoding a frame of video data that has been split into slices at a granularity smaller than an LCU, have been described with respect to specific units of video decoder 30. It should be understood, however, that the functional units provided in the example of FIG. 5 are provided for purposes of explanation. That is, certain units of video decoder 30 may be shown and described separately for purposes of explanation, but may be highly integrated, such as, for example, within an integrated circuit or other processing unit. Accordingly, functions ascribed to one unit of video decoder 30 may be performed by one or more other units of video decoder.

Accordingly, FIG. 5 provides an example of a video decoder 30 that may decode a frame of video data comprising a plurality of block-sized coding units including one or more largest coding units (LCUs) that include a hierarchically arranged plurality of relatively smaller coding units. That is, video decoder 30 may determine a granularity at which the hierarchically arranged plurality of smaller coding units has been split when forming independently decodable portions of the frame, and identify an LCU that has been split into a first section and a second section using the determined granularity. Video decoder 30 may also decode an independently decodable portion of the frame that includes the first section of the LCU without the second section of the LCU.

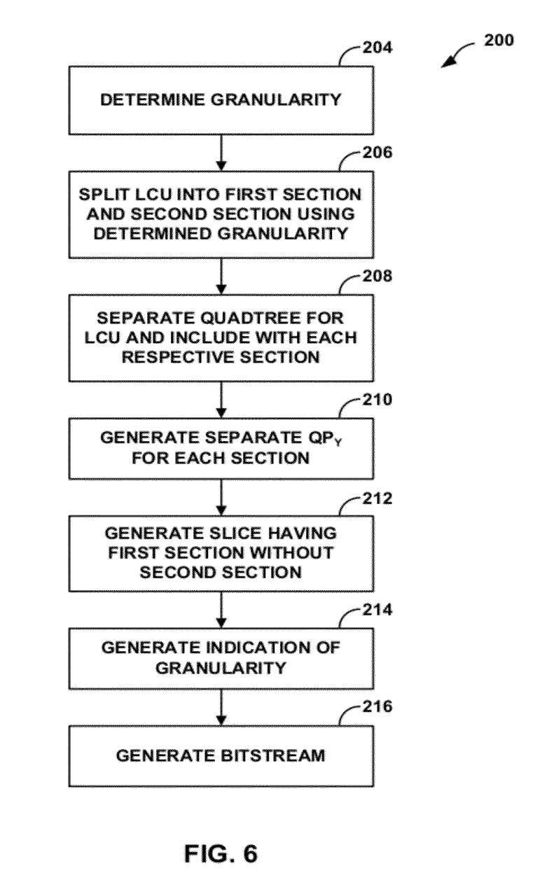

FIG. 6 is a flow diagram illustrating an encoding technique consistent with this disclosure. Although generally described as performed by components of video encoder 20 (FIG. 4) for purposes of explanation, it should be understood that other video encoding units, such as video decoder, processors, processing units, hardware-based coding units such as encoder/decoders (CODECs), and the like, may also be configured to perform the method of FIG. 6.

In the example method 220 shown in FIG. 6, video encoder 20 initially determines the granularity at which to divide a frame into slices, which according to the techniques of this disclosure, may be smaller than an LCU (204). As described above, when determining the granularity at which to split a frame of video data into slices, video encoder 20 may consider, for example, rate-distortion for various slice configurations and select a granularity that achieves a bitrate within an acceptable bitrate range while also providing a distortion within an acceptable distortion range. The acceptable bitrate range and acceptable distortion range may be defined by a profile, such as profiles specified in a video coding standard, such as the proposed HEVC standard. Additionally or alternatively, video encoder 20 may consider a target slice size when selecting a granularity. In general, increasing the granularity may allow greater control regarding the size of the slices, but may also increase the coding unit resources utilized in encoding or decoding the slices.

If video encoder 20 determines a granularity for splitting a frame of video data into slices that less than an LCU, video encoder 20 may split an LCU into a first section and a second section using the determined granularity in the process of creating slices (206). That is, video encoder 20 may identify a slice boundary that is included with an LCU. In this example, video encoder 20 may split the LCU in to a first section and a second section that is separate from the first section.

When splitting an LCU into two sections, video encoder 20 may also separate a quadtree associated with the LCU into two corresponding sections, and include the respective sections of the quadtree with the two sections of the LCU (208). For example, as described above, video encoder 20 may separate split flags associated with the first section of the LCU from split flags associated with the second section of the LCU. When encoding slices containing the sections of the LCU, video encoder 20 may only include the split flags associated with the first section of the LCU with the slice containing first section of the LCU, and the split flags associated with the section of the LCU with the slice containing the second section of the LCU.

In addition, when splitting an LCU into two sections during slice formation, video encoder 20 may generate separate quantization parameter (QP) or delta QP values for each section of the LCU. For example, video encoder 20 may generate a first QP or delta QP value for the first section of the LCU, and a second QP or delta QP value for the second section of the LCU. In some examples, the QP or delta QP value for the first section may be different than the QP or delta QP value for the second section.

Video encoder 20 may then generate an independently decodable portion of the frame containing the LCU, e.g., a slice, that includes the first section of the LCU without the second section of the LCU (212). For example, video encoder 20 may generate a slice that contains one or more full LCUs of a frame of video data, as well as the first section of the divided LCU of the frame. In this example, video encoder 20 may include the split flags and delta QP value associated with the first section of the divided LCU.

Video encoder 20 may also provide an indication of the granularity used to split the frame of video data into slices (214). For example, video encoder 20 may provide an indication of the granularity using a CU depth value at which the slice split may occur. In other examples, video encoder 20 may indicate the granularity differently. For example, video encoder 20 may indicate the granularity by otherwise identifying the size of the sub-CUs at which a slice split may occur. Additionally or alternatively, as described above, video encoder 20 may include a variety of other information with the slice, such as end of slice flags, frame parameters sets (FPSs), and the like.

Video encoder 20 may then generate a bitstream containing the video data associated with the slice, as well as the syntax information for decoding the slice (216). According to aspects of this disclosure, the generated bitstream may be transmitted to a decoder in real time (e.g., in video conferencing) or stored on a computer-readable medium for future use by a decoder (e.g., in streaming, downloading, disk access, card access, DVD, Blu-ray, and the like)

It should also be understood that the steps shown and described with respect to FIG. 6 are provided as merely one example. That is, the steps of the method of FIG. 6 need not necessarily be performed in the order shown in FIG. 6, and fewer, additional, or alternative steps may be performed. For example, according to another example, video encoder 20 may generate syntax elements (e.g., such as an indication of the granularity (214) prior to generating the slice.

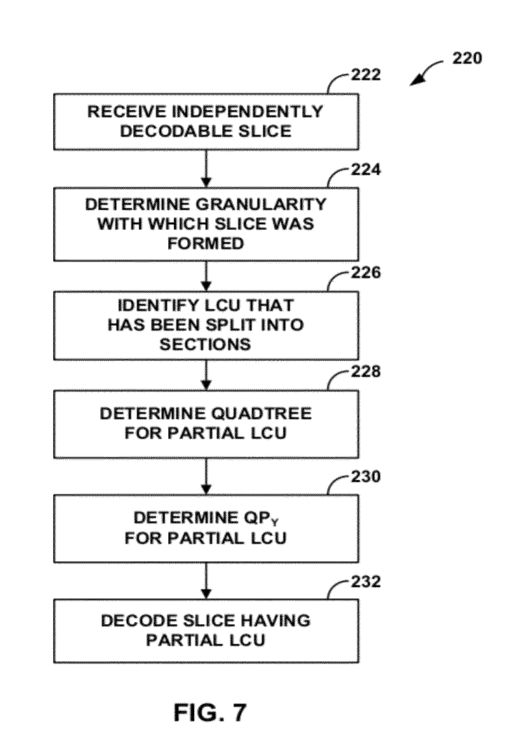

FIG. 7 is a flow diagram illustrating an decoding technique consistent with this disclosure. Although generally described as performed by components of video decoder 30 (FIG. 5) for purposes of explanation, it should be understood that other video encoding units, such as video decoder, processors, processing units, hardware-based coding units such as encoder/decoders (CODECs), and the like, may also be configured to perform the method of FIG. 7.

In the example method 220 shown in FIG. 7, video decoder 30 receives an independently decodable portion of a frame of video data, referred to herein as a slice (222). Upon receiving the slice, video decoder 30 determines the granularity at which the slice was formed, which may be smaller than an LCU (224). For example, as described above, a video encoder may generate a slice that splits an LCU into two sections, such that a first section of the LCU is included with the received slice, while a second section of the LCU is included with another slice. To determine the granularity at which the frame was split into slices, video decoder 30 may receive an indication of the granularity. That is, video decoder 30 may receive a CU depth value that identifies a CU depth at which a splice split may occur.

In examples in which a frame of video data has been split into slices at a granularity smaller than an LCU, video decoder 30 may then identify the LCU of the received slice that has been split into sections (226). Video decoder 30 may also determine the quadtree for the received section of the LCU (228). That is, video decoder 30 may identify the split flags associated with the received section of the LCU. In addition, as described above, video decoder 30 may reconstruct the quadtree associated with the entire LCU that has been split in order to properly decode the received section. Video decoder 30 may also determine a QP or delta QP value for the received section of the LCU (230).

Using the video data and associated syntax information, video decoder 30 may then decode the slice that contains the received section of the LCU (232). As described above with respect to FIG. 6, video decoder 30 may receive and utilize a variety of information for decoding the slice, including for example, end of slice flags, frame parameters sets (FPSs), and the like.

It should also be understood that the steps shown and described with respect to FIG. 7 are provided as merely one example. That is, the steps of the method of FIG. 7 need not necessarily be performed in the order shown in FIG. 7, and fewer, additional, or alternative steps may be performed.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other aspects are within the scope of the following claims.

1. A method of decoding a frame of video data comprising a plurality of block-sized coding units including one or more largest coding units (LCUs) that include a hierarchically arranged plurality of relatively smaller coding units, the method comprising:
determining a granularity at which the hierarchically arranged plurality of smaller coding units has been split when forming independently decodable portions of the frame;
identifying an LCU that has been split into a first section and a second section using the determined granularity; and
decoding an independently decodable portion of the frame that includes the first section of the LCU without the second section of the LCU.

2. The method of claim 1, wherein determining the granularity includes determining a CU depth at which the hierarchically arranged plurality of smaller coding units has been split.

3. The method of claim 2, wherein determining a CU depth at which the hierarchically arranged plurality of smaller coding units has been split comprises decoding a CU depth value in a picture parameter set.

4. The method of claim 1, further comprising determining an address of the first section of the LCU.

5. The method of claim 4, wherein determining the address of the first section of the LCU comprises decoding a slice address of a slice header.

6. The method of claim 1, wherein the independently decodable portion of the frame comprises a first independently decodable portion; and
wherein the method further comprises:
decoding a second independently decodable portion of the frame that includes the second section of the LCU; and
decoding a first portion of a quadtree structure that identifies the hierarchical arrangement of relatively smaller coding units with the first independently decodable portion; and
decoding a second portion of the quadtree structure separately from the first portion of the quadtree partitioning structure with the second independently decodable portion.

7. The method of claim 6, wherein decoding the first portion of the quadtree structure comprises:
decoding one or more split flags that indicate a coding unit division within the first independently decodable portion; and
decoding one or more split flags that indicate a coding unit division within the second independently decodable portion.

8. The method of claim 1, wherein the independently decodable portion of the frame comprises a first independently decodable portion, and
wherein the method further comprises:
decoding a second independently decodable portion of the frame that includes the second section of the LCU;
identifying a change in a quantization parameter for the first independently decodable portion; and
identifying, separately from the first independently decodable portion, a change in quantization parameter for the second independently decodable portion.

9. The method of claim 1, further comprising decoding an indication of an end of the independently decodable portion.

10. An apparatus for decoding a frame of video data comprising a plurality of block-sized coding units including one or more largest coding units (LCUs) that include a hierarchically arranged plurality of relatively smaller coding units, the apparatus comprising one or more processors configured to:
determine a granularity at which the hierarchically arranged plurality of smaller coding units has been split when forming independently decodable portions of the frame;
identify an LCU that has been split into a first section and a second section using the determined granularity; and
decode an independently decodable portion of the frame that includes the first section of the LCU without the second section of the LCU.

11. The apparatus of claim 10, wherein determining the granularity includes determining a CU depth at which the hierarchically arranged plurality of smaller coding units has been split.

12. The apparatus of claim 11, wherein determining a CU depth at which the hierarchically arranged plurality of smaller coding units has been split comprises decoding a CU depth value in a picture parameter set.

13. The apparatus of claim 10, wherein the one or more processors are further configured to determine an address of the first section of the LCU.

14. The apparatus of claim 13, wherein determining the address of the first section of the LCU comprises decoding a slice address of a slice header.

15. The apparatus of claim 10, wherein the independently decodable portion of the frame comprises a first independently decodable portion; and
wherein the one or more processors are further configured to:
decode a second independently decodable portion of the frame that includes the second section of the LCU; and
decode a first portion of a quadtree structure that identifies the hierarchical arrangement of relatively smaller coding units with the first independently decodable portion; and
decode a second portion of the quadtree structure separately from the first portion of the quadtree partitioning structure with the second independently decodable portion.

16. The apparatus of claim 15, wherein decoding the first portion of the quadtree structure comprises:
decoding one or more split flags that indicate a coding unit division within the first independently decodable portion; and
decoding one or more split flags that indicate a coding unit division within the second independently decodable portion.

17. The apparatus of claim 10, wherein the independently decodable portion of the frame comprises a first independently decodable portion, and
wherein the one or more processors are further configured to:
decode a second independently decodable portion of the frame that includes the second section of the LCU;
identify a change in a quantization parameter for the first independently decodable portion; and
identify, separately from the first independently decodable portion, a change in quantization parameter for the second independently decodable portion.

18. The apparatus of claim 10, wherein the one or more processors are further configured to decode an indication of an end of the independently decodable portion.

19. The apparatus of claim 10, wherein the apparatus comprises a mobile device.

20. An apparatus for decoding a frame of video data comprising a plurality of block-sized coding units including one or more largest coding units (LCUs) that include a hierarchically arranged plurality of relatively smaller coding units, the apparatus comprising:
means for determining a granularity at which the hierarchically arranged plurality of smaller coding units has been split when forming independently decodable portions of the frame;
means for identifying an LCU that has been split into a first section and a second section using the determined granularity; and
means for decoding an independently decodable portion of the frame that includes the first section of the LCU without the second section of the LCU.

21. The apparatus of claim 20, wherein determining the granularity includes determining a CU depth at which the hierarchically arranged plurality of smaller coding units has been split.

22. The apparatus of claim 21, wherein determining a CU depth at which the hierarchically arranged plurality of smaller coding units has been split comprises decoding a CU depth value in a picture parameter set.

23. The apparatus of claim 20, wherein the independently decodable portion of the frame comprises a first independently decodable portion; and further comprising:
means for decoding a second independently decodable portion of the frame that includes the second section of the LCU; and
means for decoding a first portion of a quadtree structure that identifies the hierarchical arrangement of relatively smaller coding units with the first independently decodable portion; and
means for decoding a second portion of the quadtree structure separately from the first portion of the quadtree partitioning structure with the second independently decodable portion.

24. A computer-readable storage medium storing instructions that, upon execution by one or more processors, cause the one or more processors to perform a method for decoding a frame of video data comprising a plurality of block-sized coding units including one or more largest coding units (LCUs) that include a hierarchically arranged plurality of relatively smaller coding units, the method comprising:
determining a granularity at which the hierarchically arranged plurality of smaller coding units has been split when forming independently decodable portions of the frame;
identifying an LCU that has been split into a first section and a second section using the determined granularity; and
decoding an independently decodable portion of the frame that includes the first section of the LCU without the second section of the LCU.

25. The computer-readable storage medium of claim 24, wherein determining the granularity includes determining a CU depth at which the hierarchically arranged plurality of smaller coding units has been split.

26. The computer-readable storage medium of claim 25, wherein determining a CU depth at which the hierarchically arranged plurality of smaller coding units has been split comprises decoding a CU depth value in a picture parameter set.

27. The computer-readable storage medium of claim 24, wherein the independently decodable portion of the frame comprises a first independently decodable portion; and wherein the method further comprises:
decoding a second independently decodable portion of the frame that includes the second section of the LCU; and
decoding a first portion of a quadtree structure that identifies the hierarchical arrangement of relatively smaller coding units with the first independently decodable portion; and
decoding a second portion of the quadtree structure separately from the first portion of the quadtree partitioning structure with the second independently decodable portion.

28. A method of encoding a frame of video data comprising a plurality of block-sized coding units including one or more largest coding units (LCUs) that include a hierarchically arranged plurality of relatively smaller coding units, the method comprising:
determining a granularity at which the hierarchically arranged plurality of smaller coding units is to be split when forming independently decodable portions of the frame;
splitting an LCU using the determined granularity to generate a first section of the LCU and a second section of the LCU;
generating an independently decodable portion of the frame to include the first section of the LCU without including the second section of the LCU; and
generating a bitstream to include the independently decodable portion of the frame and an indication of the determined granularity.

29. The method of claim 28,
wherein determining the granularity includes determining a CU depth at which the hierarchically arranged plurality of smaller coding units is to be split; and
wherein generating the bitstream includes generating the bitstream to include a CU depth value.

30. The method of claim 29, wherein generating the bitstream to include the indication of the determined granularity comprises generating the bitstream to include the CU depth value in a picture parameter set.

31. The method of claim 28, wherein the independently decodable portion of the frame comprises a first independently decodable portion; and
wherein the method further comprises:
generating a second independently decodable portion of the frame to include the second section of the LCU; and
indicating a first portion of a quadtree structure that identifies the hierarchical arrangement of relatively smaller coding units with the first independently decodable portion; and
indicating a second portion of the quadtree structure separately from the first portion of the quadtree partitioning structure with the second independently decodable portion.

32. The method of claim 31, wherein indicating the first portion of the quadtree structure comprises:
generating one or more split flags that indicate a coding unit division within the first independently decodable portion; and
generating one or more split flags that indicate a coding unit division within the second independently decodable portion.

33. The method of claim 28, wherein the independently decodable portion of the frame comprises a first independently decodable portion, and
wherein the method further comprises:
generating a second independently decodable portion of the frame to include the second section of the LCU;
indicating a change in a quantization parameter for the first independently decodable portion; and
indicating, separately from the first independently decodable portion, a change in quantization parameter for the second independently decodable portion.

34. The method of claim 28, wherein generating a bitstream to include the independently decodable portion of the frame comprises generating an indication of an end of the independently decodable portion.

35. The method of claim 34, wherein generating the indication of the end of the independently decodable portion comprises generating a one bit flag that identifies the end of the independently decodable portion.

36. The method of claim 35, wherein the one bit flag is not generated for coding units that are of a smaller granularity than the granularity at which the hierarchically arranged plurality of smaller coding units is split.

37. An apparatus for encoding a frame of video data comprising a plurality of block-sized coding units including one or more largest coding units (LCUs) that include a hierarchically arranged plurality of relatively smaller coding units, the apparatus comprising one or more processors configured to:
determine a granularity at which the hierarchically arranged plurality of smaller coding units is to be split when forming independently decodable portions of the frame;
split an LCU using the determined granularity to generate a first section of the LCU and a second section of the LCU;
generate an independently decodable portion of the frame to include the first section of the LCU without including the second section of the LCU; and
generate a bitstream to include the independently decodable portion of the frame and an indication of the determined granularity.

38. The apparatus of claim 37,
wherein determining the granularity includes determining a CU depth at which the hierarchically arranged plurality of smaller coding units is to be split; and
wherein generating the bitstream includes generating the bitstream to include a CU depth value.

39. The apparatus of claim 38, wherein generating the bitstream to include the indication of the determined granularity comprises generating the bitstream to include the CU depth value in a picture parameter set.

40. The apparatus of claim 37, wherein the independently decodable portion of the frame comprises a first independently decodable portion; and wherein the one or more processors are further configured to:
generate a second independently decodable portion of the frame to include the second section of the LCU; and
indicate a first portion of a quadtree structure that identifies the hierarchical arrangement of relatively smaller coding units with the first independently decodable portion; and
indicate a second portion of the quadtree structure separately from the first portion of the quadtree partitioning structure with the second independently decodable portion.

41. The apparatus of claim 40, wherein indicating the first portion of the quadtree structure comprises:
generating one or more split flags that indicate a coding unit division within the first independently decodable portion; and
generating one or more split flags that indicate a coding unit division within the second independently decodable portion.

42. The apparatus of claim 37, wherein the independently decodable portion of the frame comprises a first independently decodable portion, and wherein the one or more processors are further configured to:
generate a second independently decodable portion of the frame to include the second section of the LCU;
indicate a change in a quantization parameter for the first independently decodable portion; and
indicate, separately from the first independently decodable portion, a change in quantization parameter for the second independently decodable portion.

43. The apparatus of claim 37, wherein generating a bitstream to include the independently decodable portion of the frame comprises generating an indication of an end of the independently decodable portion.

44. The apparatus of claim 43, wherein generating the indication of the end of the independently decodable portion comprises generating a one bit flag that identifies the end of the independently decodable portion.

45. The apparatus of claim 44, wherein the one bit flag is not generated for coding units that are of a smaller granularity than the granularity at which the hierarchically arranged plurality of smaller coding units is split.

46. The apparatus of claim 37, wherein the apparatus comprises a mobile device.

47. An apparatus for encoding a frame of video data comprising a plurality of block-sized coding units including one or more largest coding units (LCUs) that include a hierarchically arranged plurality of relatively smaller coding units, the apparatus comprising:
means for determining a granularity at which the hierarchically arranged plurality of smaller coding units is to be split when forming independently decodable portions of the frame;
means for splitting an LCU using the determined granularity to generate a first section of the LCU and a second section of the LCU;
means for generating an independently decodable portion of the frame to include the first section of the LCU without including the second section of the LCU; and
means for generating a bitstream to include the independently decodable portion of the frame and an indication of the determined granularity.

48. The apparatus of claim 47,
wherein determining the granularity includes determining a CU depth at which the hierarchically arranged plurality of smaller coding units is to be split; and
wherein generating the bitstream includes generating the bitstream to include a CU depth value.

49. The apparatus of claim 48, wherein generating the bitstream to include the indication of the determined granularity comprises generating the bitstream to include the CU depth value in a picture parameter set.

50. The apparatus of claim 47, wherein the independently decodable portion of the frame comprises a first independently decodable portion; and further comprising:
means for generating a second independently decodable portion of the frame to include the second section of the LCU; and
means for indicating a first portion of a quadtree structure that identifies the hierarchical arrangement of relatively smaller coding units with the first independently decodable portion; and
means for indicating a second portion of the quadtree structure separately from the first portion of the quadtree partitioning structure with the second independently decodable portion.

51. The apparatus of claim 50, wherein indicating the first portion of the quadtree structure comprises:
generating one or more split flags that indicate a coding unit division within the first independently decodable portion; and
generating one or more split flags that indicate a coding unit division within the second independently decodable portion.

52. A computer-readable storage medium storing instructions that, upon execution by one or more processors, cause the one or more processors to perform a method for encoding a frame of video data comprising a plurality of block-sized coding units including one or more largest coding units (LCUs) that include a hierarchically arranged plurality of relatively smaller coding units, the method comprising:
determining a granularity at which the hierarchically arranged plurality of smaller coding units is to be split when forming independently decodable portions of the frame;
splitting an LCU using the determined granularity to generate a first section of the LCU and a second section of the LCU;
generating an independently decodable portion of the frame to include the first section of the LCU without including the second section of the LCU; and
generating a bitstream to include the independently decodable portion of the frame and an indication of the determined granularity.

53. The computer-readable storage medium of claim 52,
wherein determining the granularity includes determining a CU depth at which the hierarchically arranged plurality of smaller coding units is to be split; and
wherein generating the bitstream includes generating the bitstream to include a CU depth value.

54. The computer-readable storage medium of claim 53, wherein generating the bitstream to include the indication of the determined granularity comprises generating the bitstream to include the CU depth value in a picture parameter set.

55. The computer-readable storage medium of claim 52, wherein the independently decodable portion of the frame comprises a first independently decodable portion; the method further comprising:
generating a second independently decodable portion of the frame to include the second section of the LCU; and
indicating a first portion of a quadtree structure that identifies the hierarchical arrangement of relatively smaller coding units with the first independently decodable portion; and
indicating a second portion of the quadtree structure separately from the first portion of the quadtree partitioning structure with the second independently decodable portion.

56. The computer-readable storage medium of claim 55, wherein indicating the first portion of the quadtree structure comprises:
generating one or more split flags that indicate a coding unit division within the first independently decodable portion; and
generating one or more split flags that indicate a coding unit division within the second independently decodable portion.
